(19) United States
(12) Patent Application Publication
(10) Pub. No.: US 2019/0310755 A1
(43) Pub. Date: Oct. 10, 2019

(54) COORDINATE CORRECTION APPARATUS

(71) Applicant: Mitsubishi Electric Corporation, Tokyo (JP)

(72) Inventors: Yuichi SASAKI, Tokyo (JP); Atsushi HORI, Tokyo (JP); Kentaro MORI, Tokyo (JP); Hiroyasu NEGISHI, Tokyo (JP)

(73) Assignee: Mitsubishi Electric Corporation, Tokyo (JP)

(21) Appl. No.: 16/061,554

(22) PCT Filed: Mar. 22, 2016
(86) PCT No.: PCT/JP2016/058898

§ 371 Date: Jun. 12, 2018

(51) Int. Cl. G06F 3/041; G06F 3/044

(52) U.S. Cl. CPC G06F 3/04182; G06F 2203/04104; G06F 3/044

(57) ABSTRACT

In a coordinate correction apparatus, a coordinate acquisition unit sequentially acquires coordinates of touch positions on a touch panel when a touch operation is continued on the touch panel. When the coordinate acquisition unit acquires first coordinates which are coordinates of a new touch position, a coordinate correction unit calculates a weighted average of the first coordinates and second coordinates determined from coordinates of a past touch position acquired by the coordinate acquisition unit, with applying weighting that varies according to a touch movement amount on the touch panel. The coordinate correction unit outputs a calculation result as corrected coordinates. An application unit uses the corrected coordinates.

### TECHNICAL FIELD

The present invention relates to a coordinate correction apparatus, a coordinate correction method, and a coordinate correction program.

### BACKGROUND ART

Patent Literature 1 describes a technique for preventing a coordinate shift by averaging several samples out of coordinates acquired from a touch panel in order to display a pen trajectory on the touch panel with a smooth line.

Patent Literature 2 describes a technique of changing the number of samples of coordinates to be averaged according to a displacement direction of the coordinates in order to prevent acquisition of coordinates significantly different from original coordinates as an average value when the displacement direction of the coordinates changes on the way.

### CITATION LIST

### Patent Literature

Patent Literature 1: JP 08-272534 A

Patent Literature 2: JP 2005-085141 A

### SUMMARY OF INVENTION

### Technical Problem

An electrostatic capacitance type touch panel has a problem that the coordinates are shifted even though the same position is touched when a touch is stationary under a bad power supply environment. In order to prevent this coordinate shift by the technique described in Patent Literature 1, it is necessary to increase the number of samples of coordinates to be averaged. However, as the number of samples increases, a delay occurring during processing of a touch operation increases. This delay is a factor preventing smooth operation when the touch is moving.

Under the bad power supply environment, when the touch is stationary, not only the coordinates are shifted but also the displacement direction of the coordinates changes. In the technique described in Patent Literature 2, as the displacement direction of the coordinates changes, the number of samples of coordinates to be averaged is reduced, and thus more coordinate shift occurs.

An object of the present invention is to prevent both the coordinate shift when the touch is stationary and the delay when the touch is moving.

### Solution to Problem

A coordinate correction apparatus according to one aspect of the present invention includes:

a coordinate acquisition unit to sequentially acquire coordinates of touch positions on a touch panel when a touch operation is continued on the touch panel; and

a coordinate correction unit to, when first coordinates which are coordinates of a new touch position are acquired by the coordinate acquisition unit, calculate a weighted average of the first coordinates and second coordinates determined from coordinates of a past touch position acquired by the coordinate acquisition unit, with applying weighting that varies according to at least one of a touch movement amount and a touch movement direction on the touch panel, and output a calculation result as corrected coordinates.

### Advantageous Effects of Invention

In the present invention, the weighted average of the first coordinates which are the coordinates of the new touch position and the second coordinates determined from the coordinates of the past touch position is calculated, and the calculation result is output as the corrected coordinates. In the calculation of the weighted average, the weighting that varies according to at least one of the touch movement amount and the touch movement direction is applied. Therefore, it is possible to prevent both the coordinate shift when the touch is stationary and the delay when the touch is moving.

### BRIEF DESCRIPTION OF DRAWINGS

FIG. 1 is a block diagram showing a configuration of a coordinate correction apparatus according to Embodiment 1;

FIG. 2 is a flowchart showing operation of the coordinate correction apparatus according to Embodiment 1;

FIG. 3 is a diagram showing an example of a change in trajectory due to a difference in filter strength;

FIG. 4 is a table showing an example of a table defining a correspondence relationship between a touch movement amount and filter strength V;

FIG. 5 is a block diagram showing a configuration of a coordinate correction apparatus according to Embodiment 2;

FIG. 6 is a flowchart showing operation of the coordinate correction apparatus according to Embodiment 2;

FIG. 7 is a diagram showing an example of filter strength setting in consideration of the touch movement amount and a touch movement direction;

FIG. 8 is a diagram showing an example in which two-point touch operation of parallel movement is erroneously recognized as another two-point touch operation;

FIG. 9 is a block diagram showing a configuration of a coordinate correction apparatus according to Embodiment 3;

FIG. 10 is a flowchart showing operation of the coordinate correction apparatus according to Embodiment 3;

FIG. 11 is a diagram showing an example in which a trajectory of the two-point touch operation of parallel movement is corrected;

FIG. 12 is a block diagram showing a configuration of a coordinate correction apparatus according to Embodiment 4;

FIG. 13 is a flowchart showing operation of the coordinate correction apparatus according to Embodiment 4;

FIG. 14 is a diagram showing an example of extracting an amount of noise;

FIG. 15 is a graph showing an example of target speed setting;

FIG. 16 is a view showing an example of a strip-shaped sensor pattern;

FIG. 17 is a diagram showing an example of a change in coordinate shift due to a difference of a touch position;

FIG. 18 is a block diagram showing a configuration of a coordinate correction apparatus according to Embodiment 5;

FIG. 19 is a flowchart showing operation of the coordinate correction apparatus according to Embodiment 5;

FIG. 20 is a graph showing an example of a function of filter strength W according to a touch position Z;

FIG. 21 is a table showing an example of a table in which the filter strength W corresponding to the touch position Z is specified;

FIG. 22 is a diagram showing an example of a change in coordinate shift due to a positional relationship between two points in the two-point touch operation.

FIG. 23 is a block diagram showing a configuration of a coordinate correction apparatus according to Embodiment 6;

FIG. 24 is a flowchart showing operation of the coordinate correction apparatus according to Embodiment 6;

FIG. 25 is a graph showing an example of a function of a filter strength W_{y} according to a vertical distance H between the touch positions;

FIG. 26 is a table showing an example of a table in which the filter strength W_{y} according to the vertical distance H between the touch positions is specified;

FIG. 27 is a table showing an example of a table in which the filter strength W_{y} according to a relative position of the touch position with respect to a touch sensor 105 and the vertical distance H between the touch positions is specified;

FIG. 28 is a diagram showing an example of a variation in moving speed of a GUI component due to a difference between a drawing interval and a touch interval;

FIG. 29 is a block diagram showing a configuration of a coordinate correction apparatus according to Embodiment 7;

FIG. 30 is a flowchart showing operation of the coordinate correction apparatus according to Embodiment 7;

FIG. 31 is a diagram showing an example of the drawing interval and the touch interval; and

FIG. 32 is a diagram showing an example of filter strength setting in consideration of the drawing interval and the touch interval.

### DESCRIPTION OF EMBODIMENTS

Hereinafter, embodiments of the present invention will be described with reference to the drawings. In the drawings, the same or corresponding parts are denoted by the same reference numerals. In description of the embodiments, the same or corresponding parts will be omitted or appropriately simplified.

### Embodiment 1

### Description of Configuration

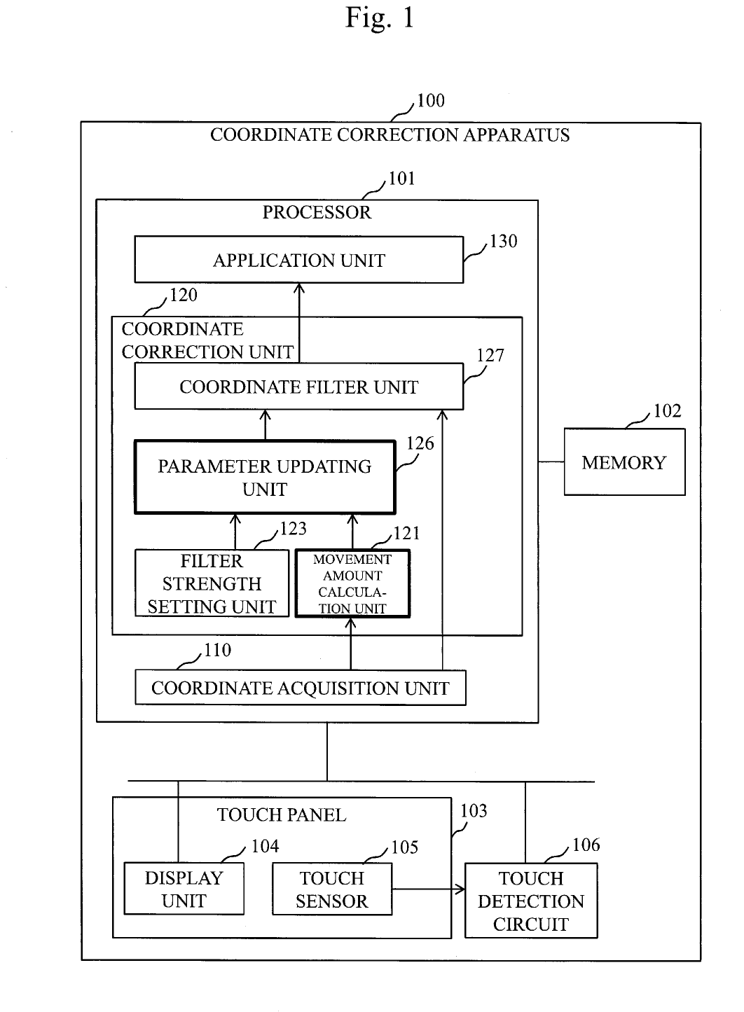

Configuration of a coordinate correction apparatus 100 according to the present embodiment will be described with reference to FIG. 1.

The coordinate correction apparatus 100 is a computer. The coordinate correction apparatus 100 includes hardware such as a processor 101, a memory 102, a touch panel 103, and a touch detection circuit 106. The processor 101 is connected to other hardware via a signal line, and controls the other hardware.

The coordinate correction apparatus 100 includes a coordinate acquisition unit 110, a coordinate correction unit 120 and an application unit 130 as functional elements. In the present embodiment, the coordinate correction unit 120 includes a movement amount calculation unit 121, a filter strength setting unit 123, a parameter updating unit 126, and a coordinate filter unit 127. Functions of the “units” such as the coordinate acquisition unit 110, the coordinate correction unit 120 and the application unit 130 are implemented by software. Note that the application unit 130 may be provided outside the coordinate correction apparatus 100.

The processor 101 is an integrated circuit (IC) which performs processing. Specifically, the processor 101 is a central processing unit (CPU).

Specifically, the memory 102 is a flash memory or a random access memory (RAM).

The touch panel 103 includes a display unit 104 and a touch sensor 105. The display unit 104 is specifically a liquid crystal display (LCD). The touch sensor 105 is specifically a capacitance type sensor, but may be a sensor of another type such as a resistance film type or the like. In the present embodiment, the touch sensor 105 is grid-like X electrodes and Y electrodes, which are constituted by indium tin oxides (ITOs) arranged perpendicular to each other in vertical and lateral directions.

The touch detection circuit 106 is an IC for detecting a touch position on the touch panel 103. The touch detection circuit 106 applies a signal for detecting an electrostatic capacitance to each electrode of the touch sensor 105. The touch detection circuit 106 detects the touch position from a change in the signal when a finger touches the touch panel 103. The touch detection circuit 106 transmits coordinates of the detected touch position to the processor 101.

The coordinate correction apparatus 100 may include a communication device as hardware.

The communication device includes a receiver for receiving data and a transmitter for transmitting data. Specifically, the communication device is a communication chip or a network interface card (NIC).

In the memory 102, a program for implementing the functions of the “units” is stored. The program is read into the processor 101 and executed by the processor 101. An operating system (OS) for providing a graphic user interface (GUI) is also stored in the memory 102. The processor 101 executes the program for implementing the functions of the coordinate acquisition unit 110 and the coordinate correction unit 120 while executing the OS. Alternatively, the processor 101 executes the OS as the program for implementing the functions of the coordinate acquisition unit 110 and the coordinate correction unit 120. The memory 102 also stores an application program which uses the GUI. The processor 101 executes the application program as the program for implementing the function of the application unit 130 while executing the OS.

It should be noted that the program and the OS for realizing the functions of the “units” may be stored in an auxiliary storage device. Specifically, the auxiliary storage device is a flash memory or hard disk drive (HDD). The program and the OS stored in the auxiliary storage device are loaded into the memory 102 and executed by the processor 101.

The coordinate correction apparatus 100 may include only one processor 101 or a plurality of processors 101. The plurality of processors 101 may execute the program for implementing the functions of the “units” in cooperation with each other.

Information, data, signal values and variable values indicating processing results of the “units” are stored in the memory 102, the auxiliary storage device, or a register or a cache memory in the processor 101.

The program for implementing the functions of the “units” may be stored in a portable recording medium such as a magnetic disk or an optical disk.

### Description of Operation

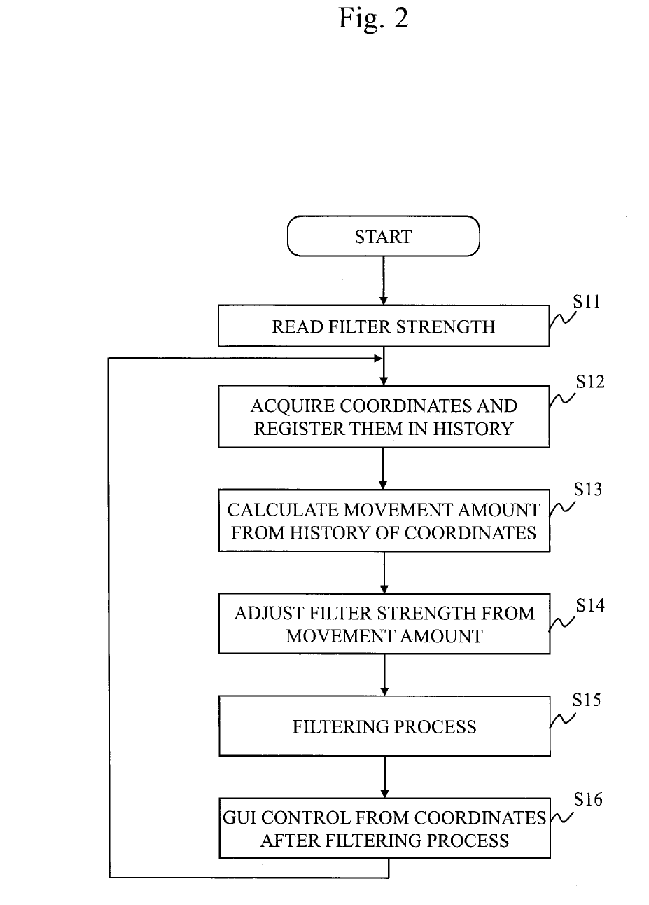

An operation of the coordinate correction apparatus 100 according to the present embodiment will be described with reference to FIG. 2. The operation of the coordinate correction apparatus 100 corresponds to a coordinate correction method according to the present embodiment. The operation of the coordinate correction apparatus 100 corresponds to processing procedures of a coordinate correction program according to the present embodiment.

In Step S11, the filter strength setting unit 123 sets a filter strength in the parameter updating unit 126. Specifically, the filter strength setting unit 123 reads a filter strength parameter stored in the memory 102 in advance, and inputs the filter strength parameter to the parameter updating unit 126.

In Step S12, the coordinate acquisition unit 110 acquires the coordinates of the touch position output from the touch panel 103. Specifically, the coordinate acquisition unit 110 receives the coordinates transmitted from the touch detection circuit 106. When a history of the coordinates of the touch positions is stored in the memory 102, the coordinate acquisition unit 110 registers the acquired coordinates in the history. When the history of the coordinates of the touch positions is not stored in the memory 102, the coordinate acquisition unit 110 stores in the memory 102 a new history in which the acquired coordinates are registered.

In Step S13, the movement amount calculation unit 121 calculates a touch movement amount from a coordinate point sequence registered in the history. Specifically, the movement amount calculation unit 121 calculates a distance between coordinates filtered last time and coordinates acquired this time as the touch movement amount. Note that the movement amount calculation unit 121 may calculate the touch movement amount by another method. Specifically, the movement amount calculation unit 121 may calculate as the touch movement amount a difference between an average value of coordinates in a first half N/2 and an average value of coordinates in a second half N/2 in the coordinate point sequence for N times. Here, N is an even number of 4 or more. Alternatively, the movement amount calculation unit 121 may apply a plurality of filtering methods and calculate the touch movement amount based on a difference between the coordinates acquired after a filtering process. Alternatively, the movement amount calculation unit 121 may calculate the touch movement amount by averaging or a combination of the plurality of filtering methods. The movement amount calculation unit 121 stores the calculated touch movement amount in the memory 102.

In Step S14, the parameter updating unit 126 adjusts the filter strength based on the filter strength set in Step S11 and the touch movement amount calculated in Step S13. Specifically, the parameter updating unit 126 determines the filter strength from the filter strength parameter input by the filter strength setting unit 123 and the touch movement amount stored in the memory 102, and stores the final filter strength parameter in the memory 102.

In Step S15, the coordinate filter unit 127 applies a filter based on the filter strength adjusted by the parameter updating unit 126 and the coordinates acquired by the coordinate acquisition unit 110. Specifically, the coordinate filter unit 127 performs the filtering process based on the filter strength parameter stored in the memory 102, the coordinates of a current touch position, and coordinates after a past filtering process, and stores the acquired coordinates in the memory 102. In the present embodiment, the coordinate filter unit 127 reads the filter strength parameter input by the parameter updating unit 126, current coordinates, and the coordinates after the last filtering process from the memory 102, performs the filtering process according to the following Equation 1, and stores the obtained result in the memory 102.

Pᵢ=(W·X+V·Pᵢ₋₁)/(W+V) Equation 1

Here, Pi is the coordinates after the filtering process, Pᵢ₋₁ is the coordinates filtered last time, X is the acquired coordinates of the current touch position, and W and V are the filter strengths adjusted by the parameter updating unit 126. In Equation 1, when there are no coordinates filtered last time, P₀=X.

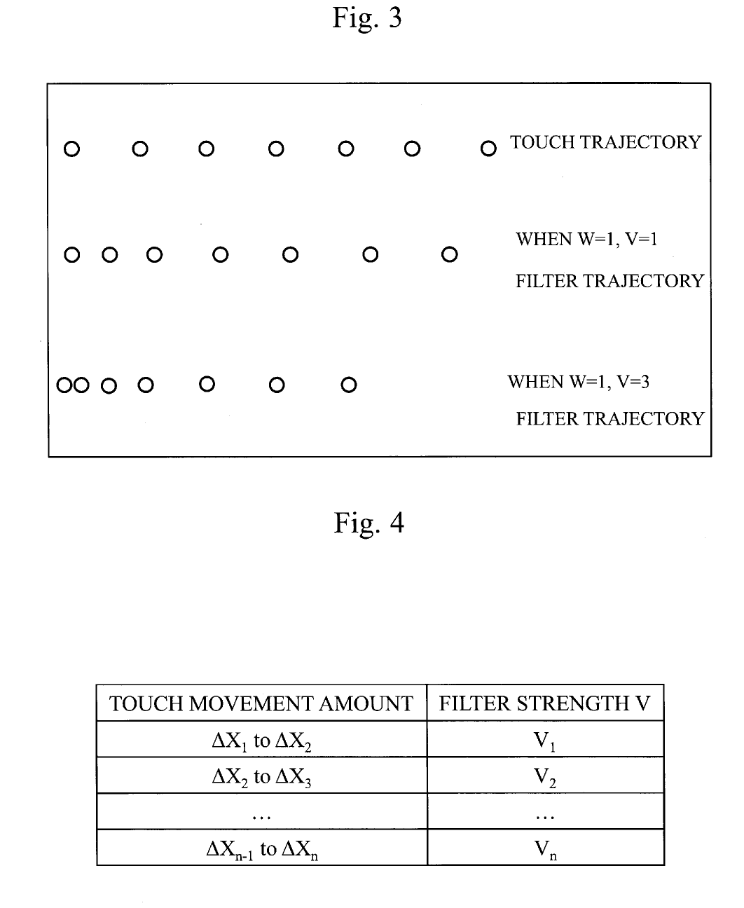

FIG. 3 shows a change in trajectory when the finger is moved at a constant speed, a value of W is fixed and a value of V is gradually increased in Equation 1, and when the filter is applied. As the V is larger, a weight of the coordinates filtered last time is larger, and followability to the finger is reduced, however, it is possible to prevent a coordinate shift. When an operation such as scrolling a list on a screen is performed, the shift when the finger moves slowly looks outstanding, however, the shift when the finger moves quickly is smaller than a movement amount of the finger, and thus it is difficult to see the shift during scrolling. When an operation such as tapping the list on the screen is performed, if the coordinate shift occurs, it may be erroneously recognized as an operation of scrolling the list.

From the above, in the filter for preventing the coordinate shift, it is preferred that the strength is increased to prevent the shift when the finger is presumed to be stationary, and the strength is decreased to improve the followability when the finger is presumed to be moving.

In step S14, for the above reason, by adjusting the filter strength using the touch movement amount calculated in step S13, the filter suitable for both moving and stationary can be performed. Specifically, the parameter updating unit 126 uses the filter strength parameter stored in the memory 102 by the filter strength setting unit 123 for W of Expression 1. For V in Equation 1, the parameter updating unit 126 reads a touch movement amount ΔX stored in the memory 102 by the movement amount calculation unit 121, and adjusts the filter strength by setting V=A·ΔX. Here, A is an adjustment parameter for calculating V. Alternatively, the parameter updating unit 126 reads a current touch movement amount ΔXᵢ stored in the memory 102 by the movement amount calculation unit 121 and a previous touch movement amount ΔXᵢ₋₁ and adjusts the filter strength also considering a past touch movement amount by setting V=A·ΔXᵢ+B·ΔXᵢ₋₁. Here, A and B are adjustment parameters for calculating V. Alternatively, the parameter updating unit 126 reads the current touch movement amount ΔX stored in the memory 102 by the movement amount calculation unit 121, and adjusts the filter strength with reference to a table in which a correspondence relationship between the touch movement amount and a filter strength V is defined as shown in FIG. 4. It should be noted that the parameter updating unit 126 may read the touch movement amount stored in the memory 102 by the movement amount calculation unit 121, and adjust the filter strength by any method using a table or an equation in which a relationship between the touch movement amount from past to present and V is defined.

In Step S16, the application unit 130 performs GUI control during touch operation by using the coordinates filtered by the coordinate filter unit 127. Specifically, the application unit 130 reads the filtered coordinates from the memory 102 and performs touch event control and movement of a GUI component according to the coordinates. The application unit 130 transmits a GUI display command to the display unit 104.

After a process of Step S16, a process in Step S12 is performed again.

As described above, in Step S12, the coordinate acquisition unit 110 sequentially acquires coordinates of touch positions on the touch panel 103 when the touch operation on the touch panel 103 is continued. In Steps S13 to S15, when first coordinates which are the coordinates of a new touch position are acquired by the coordinate acquisition unit 110, the coordinate correction unit 120 calculates a weighted average of the first coordinates and second coordinates determined from the coordinates of a past touch position acquired by the coordinate acquisition unit 110, with applying weighting that varies according to the touch movement amount on the touch panel 103. The coordinate correction unit 120 outputs the calculation result as corrected coordinates. In Step S16, the application unit 130 uses the corrected coordinates.

In the present embodiment, Pᵢ in Equation 1 corresponds to the corrected coordinates output by the coordinate correction unit 120. Further, X in Equation 1 corresponds to the first coordinates, and the corrected coordinates output in the past by the coordinate correction unit 120, specifically Pᵢ₋₁ in Equation 1, corresponds to the second coordinates.

As described above, the capacitance type touch panel 103 has a problem that the coordinates are shifted even though the same position is touched when a touch is stationary under a bad power supply environment. In the present embodiment, by applying weighting that varies according to the touch movement amount, it is possible to prevent the coordinate shift when the touch is stationary without increasing the number of samples of coordinates to be averaged. In Equation 1, the number of samples is only two in total, one pair of first coordinates and one pair of second coordinates. In this way, when the number of samples is small, a delay generated during processing of the touch operation is small. Therefore, it is possible to perform a smooth operation during touch movement. Although it is desirable that the number of samples is small, three or more samples may be used.

In the present embodiment, the coordinate correction unit 120 sets the weight of the second coordinates larger as the touch movement amount is smaller. Therefore, it is possible to prevent both the coordinate shift noticeable when the touch movement amount is small and the delay noticeable when the touch movement amount is large.

As described above, in the present embodiment, the filter strength is switched according to the touch movement amount, and the coordinates of the current touch position is filtered. Therefore, it is possible to realize a filter for further preventing the shift when the finger is stationary, and to realize the filter for further preventing the delay due to the filtering process when the finger is moving.

In the present embodiment, when the list on the screen is scrolled, by performing the above-described filtering process, it is possible to reduce visual shift and erroneous operation such as a tap or long press, and to prevent the delay of scrolling when the finger is moved.

In the present embodiment, a method of strengthening or weakening the filter is adopted when the filter is applied based on Equation 1, but in addition to this, a Kalman filter can be applied.

When using the Kalman filter, it is considered that an error is included in the coordinates of the touch position to be observed. The coordinates are estimated from the coordinates of a past touch position, moving speed and the like. It is considered that an error is included in the estimated coordinates. The filter is applied so that the weight of the coordinates having a smaller error out of an observed value and the estimated coordinates is larger. In order to adjust this weight, it is sufficient to set an observation error R and an error Q when estimating a coordinate position.

When this is applied to the filter strength of the present embodiment, if a value stored in the memory 102 by the filter strength setting unit 123 is set to R, and the touch movement amount calculated by the movement amount calculation unit 121 is set to Q, Q becomes large when the finger moves much, and thus the weight is calculated to use the observed coordinates themselves rather than the estimated values of the coordinates. When the finger does not move so much, Q becomes small, and thus the weight is calculated to use the coordinates estimated from the speed and the like rather than the observed coordinates. This makes it possible to obtain the same effect as when increasing or decreasing V in Equation 1.

When the present embodiment is applied to the Kalman filter, the coordinates estimated to be acquired next from the coordinates of the past touch position by the coordinate acquisition unit 110 corresponds to the above-described second coordinates.

By increasing or decreasing the filter strength according to the touch movement amount for all filters using coordinates other than the above, it is possible to obtain the same effect as in the present embodiment.

### Description of Effect of Embodiment

In the present embodiment, the weighted average of the first coordinates which are the coordinates of the new touch position and the second coordinates determined from the coordinates of the past touch position is calculated, and the calculation result is output as the corrected coordinates. In the calculation of the weighted average, the weighting that varies according to the touch movement amount is applied. Therefore, it is possible to prevent both the coordinate shift when the touch is stationary and the delay when the touch is moving.

In the present embodiment, the filter is strengthened or weakened according to the touch movement amount. Specifically, when the touch movement amount obtained by the movement amount calculation unit 121 is large, the parameter updating unit 126 decreases the filter strength, and thus it is possible to improve the followability of the touch operation. Further, when the touch movement amount obtained by the movement amount calculation unit 121 is small, the parameter updating unit 126 increases the filter strength, and thus it is possible to improve performance of preventing the coordinate shift.

The present embodiment can also be applied to the Kalman filter. Specifically, an error of the observed value obtained from the touch panel 103 is set in advance. A next touch position is estimated from the moving speed and position of the coordinate point sequence given from the coordinate acquisition unit 110. An error of the estimated touch position is also set. The parameter updating unit 126 adjusts the filter strength based on the weights of the error of the estimated touch position and the error of the observed value. A constant is set for the error of the observed value. A value corresponding to the touch movement amount calculated by the movement amount calculation unit 121 is set for the error of the estimated touch position.

### Other Configurations

In the present embodiment, the functions of “units” are realized by software, but as a modification, the functions of “units” may be realized by a combination of software and hardware. That is, the functions of one or several “units” may be realized by dedicated hardware and other functions may be realized by software.

The processor 101, the memory 102, and the touch detection circuit 106 are collectively referred to as “processing circuitry”. When the functions of “units” are realized by software, and when the functions of “units” are realized by the combination of software and hardware, the functions of “units” are realized by the processing circuitry.

The “units” may be replaced by “steps”, “procedures” or “processes”.

### Embodiment 2

In the present embodiment, differences from Embodiment 1 will be mainly described.

In Embodiment 1, the followability of the operation is improved by using the parameter of the touch movement amount, but in the present embodiment, the followability is further improved by using a parameter of a touch movement direction.

### Description of Configuration

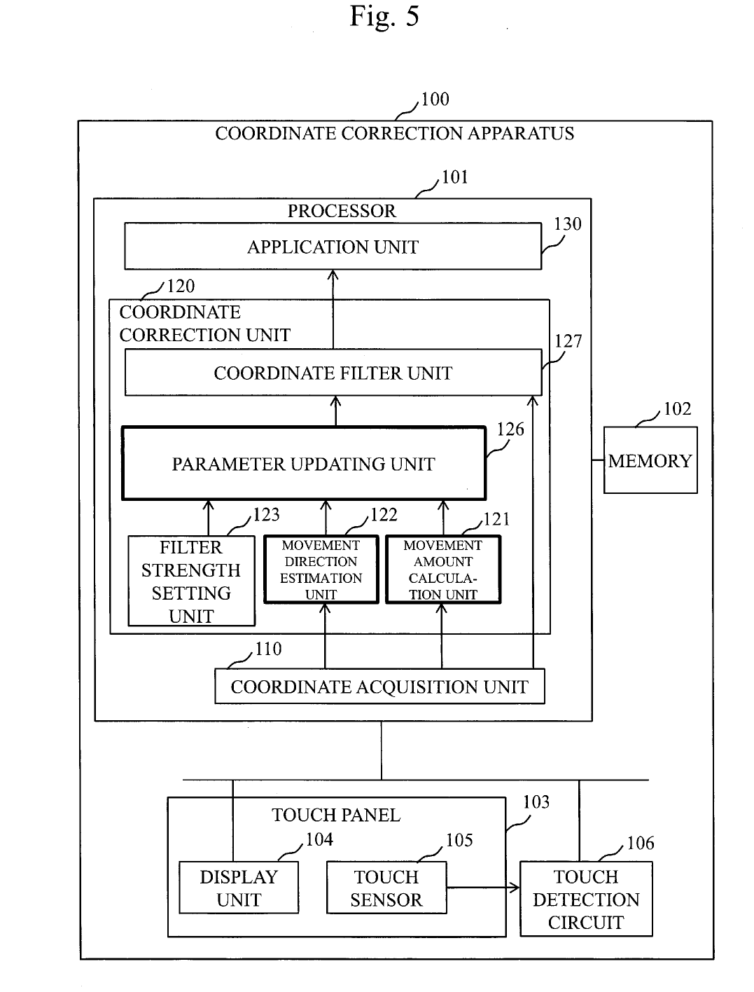

The configuration of the coordinate correction apparatus 100 according to the present embodiment will be described with reference to FIG. 5.

In the present embodiment, the coordinate correction unit 120 includes the movement amount calculation unit 121, a movement direction estimation unit 122, the filter strength setting unit 123, the parameter updating unit 126 and the coordinate filter unit 127.

### Description of Operation

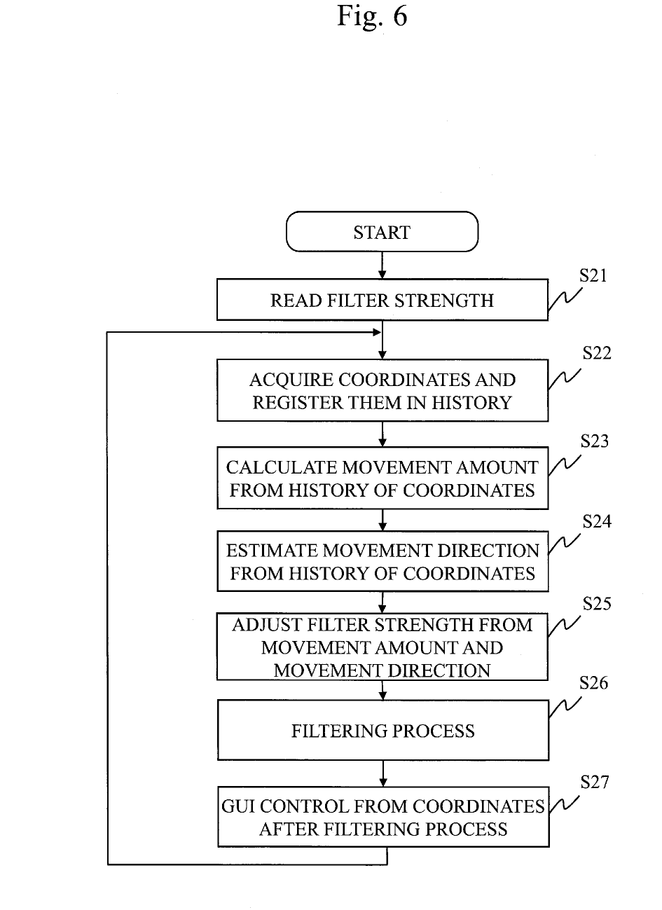

The operation of the coordinate correction apparatus 100 according to the present embodiment will be described with reference to FIG. 6. The operation of the coordinate correction apparatus 100 corresponds to a coordinate correction method according to the present embodiment. The operation of the coordinate correction apparatus 100 corresponds to processing procedures of a coordinate correction program according to the present embodiment.

Since processes from Step S21 to Step S23 are the same as processes from Step S11 to Step S13 in Embodiment 1, description thereof will be omitted.

In Step S24, the movement direction estimation unit 122 estimates the touch movement direction based on the coordinate point sequence registered in the history stored in the memory 102. Specifically, the movement direction estimation unit 122 obtains the touch movement direction by calculating a direction of movement vector from the coordinates filtered last time to the coordinates acquired this time. Note that the movement direction estimation unit 122 may estimate the touch movement direction by other methods. Specifically, the movement direction estimation unit 122 may estimate the touch movement direction by calculating an approximate straight line of the coordinate point sequence for M times. Here, M is an integer of three or more. The movement direction estimation unit 122 stores the estimated touch movement direction in the memory 102.

In Step S25, the parameter updating unit 126 adjusts the filter strength based on the filter strength set in Step S21, the touch movement amount calculated in Step S23, and the touch movement direction calculated in Step S24. Specifically, the parameter updating unit 126 determines the filter strength from the filter strength parameter input by the filter strength setting unit 123, and the touch movement amount and the touch movement direction stored in the memory 102, and stores the final filter strength parameter in the memory 102.

Since a process in Step S26 is the same as a process in Step S15 in Embodiment 1, detailed description thereof will be omitted, however, also in the present embodiment, the coordinate filter unit 127 performs the filtering process according to Equation 1 described above.

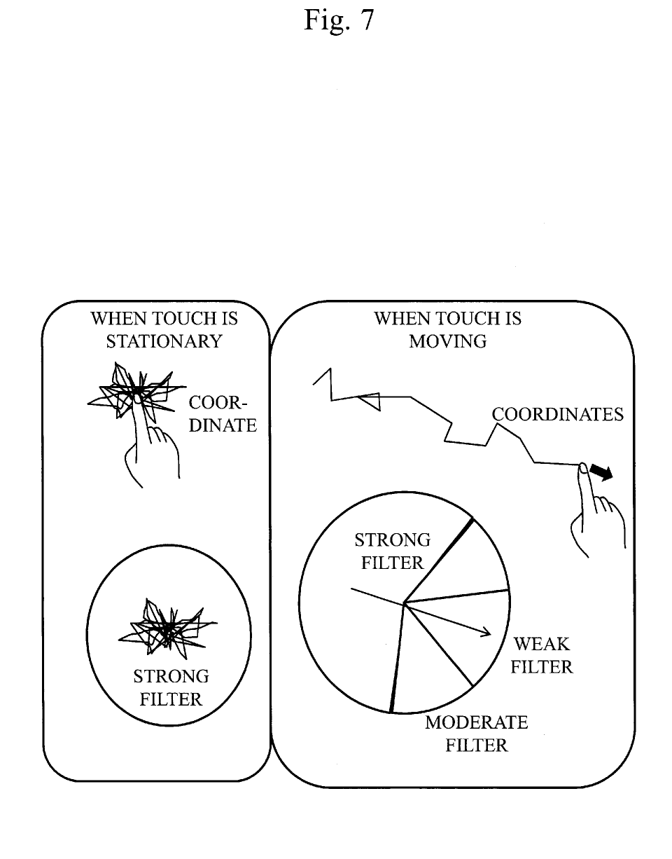

In Step S25, the filter strength is adjusted by using the touch movement amount and the touch movement direction calculated in Steps S23 and S24, so that the filter suitable for both the touch moving and stationary can be performed. Specifically, the parameter updating unit 126 uses the filter strength parameter stored in the memory 102 by the filter strength setting unit 123 for W in Equation 1. For V in Equation 1, the parameter updating unit 126 reads the touch movement amount ΔX stored in the memory 102 by the movement amount calculation unit 121, and adjusts the filter strength by setting V=A·ΔX. Here, A is a filter strength determination coefficient determined from the touch movement direction. As a specific example, the parameter updating unit 126 reads the current and past touch movement directions stored in the memory 102 by the movement direction estimation unit 122, and sets A large when the finger is not moving as shown in FIG. 7. The parameter updating unit 126 sets A small when the finger is moving in the same direction. The parameter updating unit 126 sets A moderate when the finger is moving obliquely. The parameter updating unit 126 sets A large when the finger is moving in a reverse direction. This makes it possible to determine the filter strength in consideration of the touch movement amount and the touch movement direction.

Since a process in Step S27 is the same as a process in Step S16 in Embodiment 1, description thereof will be omitted.

After the process in Step S27, a process in Step S22 is performed again.

As described above, in Step S22, the coordinate acquisition unit 110 sequentially acquires the coordinates of the touch positions on the touch panel 103 when the touch operation on the touch panel 103 is continued. In Steps S23 to S26, when first coordinates which are the coordinates of a new touch position are acquired by the coordinate acquisition unit 110, the coordinate correction unit 120 calculates the weighted average of the first coordinates and second coordinates determined from the coordinates of a past touch position acquired by the coordinate acquisition unit 110, with applying weighting that varies according to both the touch movement amount and the touch movement direction on the touch panel 103. The coordinate correction unit 120 outputs the calculation result as the corrected coordinates. In Step S27, the application unit 130 uses the corrected coordinates. It should be noted that the weighting applied by the coordinate correction unit 120 may vary according to only the touch movement direction out of the touch movement amount and the touch movement direction on the touch panel 103.

As described above, the capacitance type touch panel 103 has a problem that the coordinates are shifted even though the same position is touched when the touch is stationary under the bad power supply environment. In the present embodiment, by applying weighting that varies according to the touch movement direction, it is possible to prevent the coordinate shift when the touch is stationary without increasing the number of samples of the coordinates to be averaged. In Equation 1, the number of samples is only two in total, one pair of first coordinates and one pair of second coordinates. In this way, when the number of samples is small, the delay generated during processing of the touch operation is small. Therefore, it is possible to perform the smooth operation during touch movement. Although it is desirable that the number of samples is small, three or more samples may be used.

In the present embodiment, the coordinate correction unit 120 sets the weight of the second coordinates larger as a change of the touch movement direction is larger. Therefore, it is possible to prevent both the coordinate shift noticeable when the change of the touch movement direction is large and the delay noticeable when the change of the touch movement direction is small.

As described above, in the present embodiment, since the filter strength is increased or decreased in consideration of the touch movement direction in addition to the touch movement amount, it is possible to improve the followability when the touch is moving in the same direction. In addition, when there is a movement like the coordinate shift which often goes in different directions, by strengthening the filter it is possible to improve the followability to a direction in which a user performs an operation and to improve accuracy of the filter.

### Description of Effect of Embodiment

In the present embodiment, the weighted average of the first coordinates which are the coordinates of the new touch position and the second coordinates determined from the coordinates of the past touch position is calculated, and the calculation result is output as the corrected coordinates. In the calculation of the weighted average, the weighting that varies according to the touch movement direction or both the touch movement amount and the touch movement direction is applied. Therefore, it is possible to prevent both the coordinate shift when the touch is stationary and the delay when the touch is moving.

In the present embodiment, the filter is strengthened or weakened according to the touch movement direction in addition to the touch movement amount. Specifically, when the directions estimated by the movement direction estimation unit 122 are the same, the parameter updating unit 126 can decrease the filter strength to improve the followability. When the directions estimated by the movement direction estimation unit 122 are different, the parameter updating unit 126 can increase the filter strength to improve the performance of preventing the coordinate shift.

### Other Configurations

In the present embodiment, the functions of “units” are realized by software as in Embodiment 1, however, the functions of “units” may be realized by hardware as in the modification of Embodiment 1. Alternatively, the functions of “units” may be realized by the combination of software and hardware.

### Embodiment 3

In the present embodiment, differences from Embodiment 2 will be mainly described.

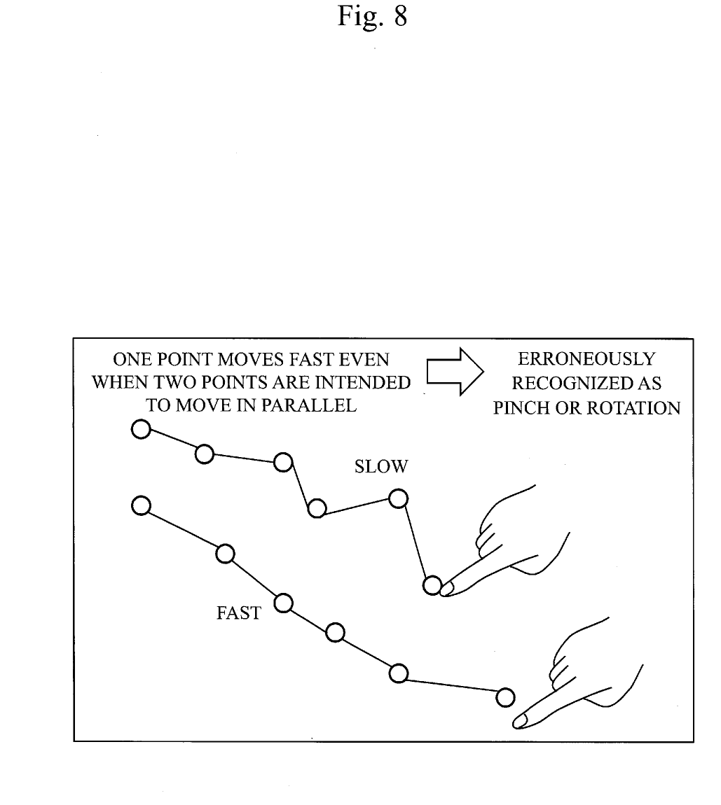

In Embodiment 2, attention is paid to a direction of one-point tracing operation, but in case of two-point touch operation, the operation may not match the operation actually intended by the user. As a specific example, as shown in FIG. 8, when a touch operation such as scrolling in parallel at two points is performed, the touch movement amounts of a first point and a second point may not be the same. Such a touch operation is not regarded as the touch operation moving in parallel in the prior art, but may be erroneously recognized as a touch gesture such as a pinch widening a distance between fingers, or a touch gesture such as a rotation moving two fingers to draw a circle. In this way, when a person performs the two-point touch operation, it is difficult to strictly move the fingers in parallel. In the present embodiment, such an operation can also be correctly recognized as parallel movement.

### Description of Configuration

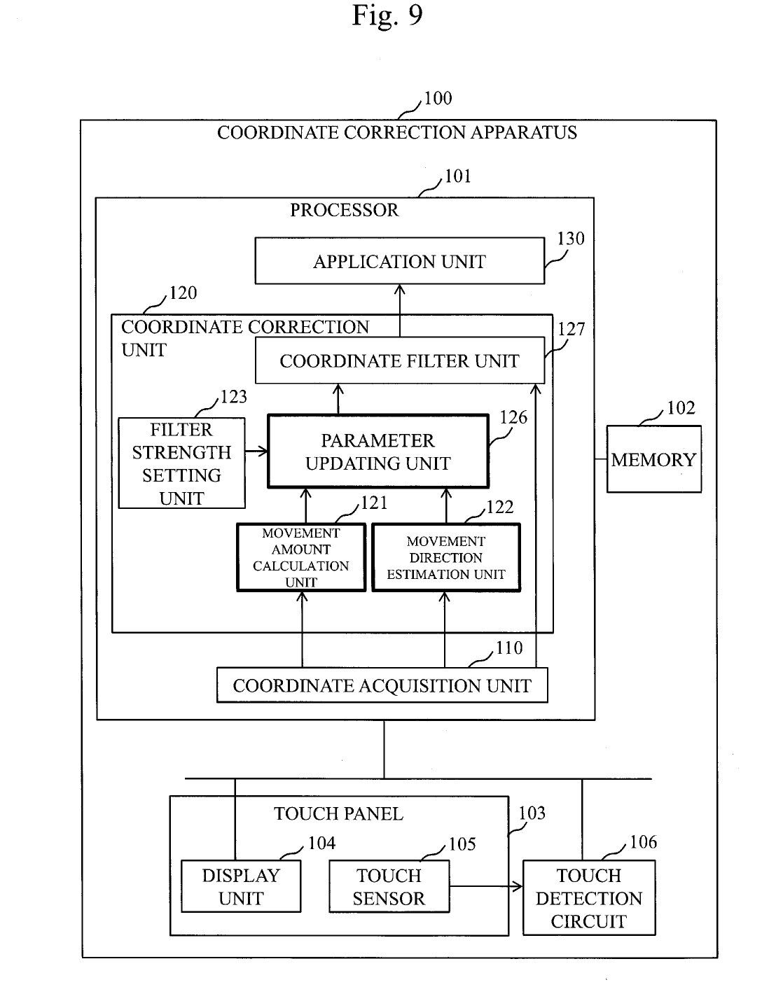

The configuration of the coordinate correction apparatus 100 according to the present embodiment will be described with reference to FIG. 9.

In the present embodiment, the coordinate correction unit 120 includes the movement amount calculation unit 121, the movement direction estimation unit 122, the filter strength setting unit 123, the parameter updating unit 126, and the coordinate filter unit 127.

### Description of Operation

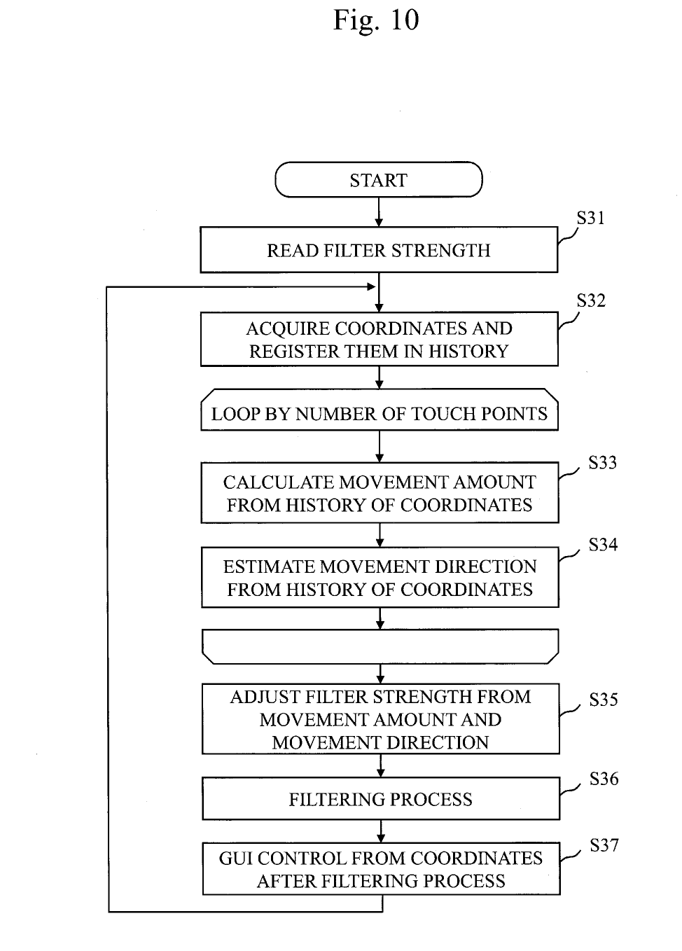

The operation of the coordinate correction apparatus 100 according to the present embodiment will be described with reference to FIG. 10. The operation of the coordinate correction apparatus 100 corresponds to a coordinate correction method according to the present embodiment. The operation of the coordinate correction apparatus 100 corresponds to processing procedures of a coordinate correction program according to the present embodiment.

Since processes in Step S31 and Step S32 are the same as processes in Step S21 and Step S22 in Embodiment 2, description thereof will be omitted.

Processes in Steps S33 and S34 are repeated by the number of touch points.

Since the process in Step S33 is almost the same as a process in Step S23 in Embodiment 2, detailed description thereof will be omitted, but in the present embodiment, the movement amount calculation unit 121 calculates the touch movement amounts of respective fingers based on the history of the coordinates of multi-touch stored in the memory 102 by the coordinate acquisition unit 110.

Since the process in Step S34 is almost the same as a process in Step S24 in Embodiment 2, detailed description thereof will be omitted, but in the present embodiment, the movement direction estimation unit 122 estimates the touch movement directions of the respective fingers based on the history of the coordinates of the multi-touch stored in the memory 102 by the coordinate acquisition unit 110.

In Step S35, when the touch movement directions of respective points obtained in Step S34 are the same, the parameter updating unit 126 adjusts the filter strength so that the touch movement amounts of the respective points are the same. That is, the parameter updating unit 126 adjusts the filter strength so that the touch movement amounts of the respective fingers during parallel movement is the same. When the touch movement directions of the respective points obtained in Step S34 are different, the parameter updating unit 126 adjusts the filter strength for the respective points as in Embodiment 2.

Since processes in Step S36 and Step S37 are the same as processes in Step S26 and Step S27 in Embodiment 2, description thereof will be omitted.

After the process in Step S37, the process in Step S32 is performed again.

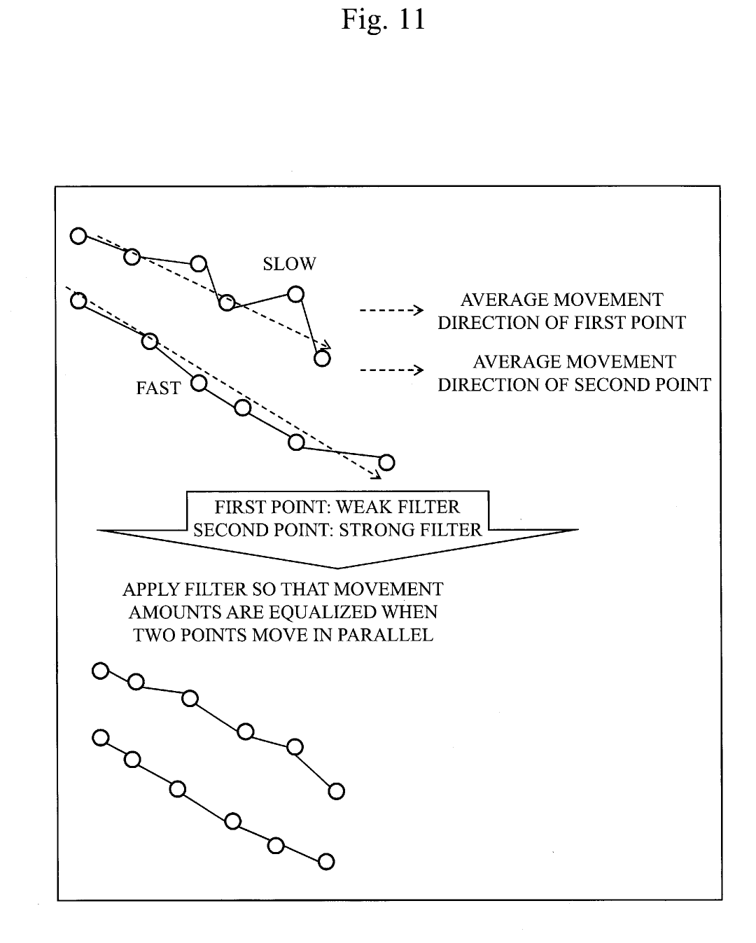

FIG. 11 shows an example in which processes from Step S31 to Step S37 are applied. In this example, whereas the user is trying to trace two points in parallel, the first point is moving more slowly and the second point is moving faster in the coordinates actually detected.

In FIG. 11, the touch movement directions of the first point and the second point obtained by a process of the movement direction estimation unit 122 are indicated by dotted arrows. The parameter updating unit 126 calculates an angle formed by the two dotted arrows, and assumes that they are the same directions when this angle is a certain value or less. From the touch movement amounts of the first point and the second point obtained by a process of the movement amount calculation unit 121, the parameter updating unit 126 calculates a ratio of the touch movement amount from the past to the present for the first point and the second point. From this ratio, as shown in FIG. 11, the parameter updating unit 126 adjusts the filter strength so that the two points are moved in parallel by decreasing the filter strength of a slower speed point and increasing the filter strength of a higher speed point.

As described above, in Step S32, the coordinate acquisition unit 110 sequentially acquires the coordinates of the touch positions on the touch panel 103 when the multi-touch operation of simultaneously performing touch operations at a plurality of positions on the touch panel 103 is continued. In Step S35, when the coordinate acquisition unit 110 acquires the coordinates of the touch positions as the first coordinates and a difference between the touch movement directions at the plurality of positions is equal to or less than a threshold value, the coordinate correction unit 120 sets the weight of the second coordinates larger at a position in which the touch movement amount is larger among the plurality of positions.

As described above, in the present embodiment, when the two points are moving in different directions, the filter strength is set in consideration of the touch movement amount and the touch movement direction of each point. When the two points are moving in exactly the same direction or nearly the same direction, the filter strength is adjusted so that the touch movement amounts of the two points is the same, and thus it is possible to prevent erroneous recognition of the touch operation as the pinch or the rotation even when only one finger moves fast during the parallel movement of the two points.

### Description of Effect of Embodiment

In the present embodiment, the filter is strengthened or weakened according to the touch movement direction of each point of the multi-touch, and the touch movement amounts of the two points in case of the parallel movement are equalized. Specifically, when the touch movement direction of each point obtained by the movement direction estimation unit 122 is the same direction, the parameter updating unit 126 adjusts the filter strength so that the touch movement amount of each point is the same, and thus it is possible to prevent erroneous recognition. When the touch movement direction of each point obtained by the movement direction estimation unit 122 is different, the parameter updating unit 126 adjusts the parameter according to the touch movement direction and the touch movement amount as in Embodiment 2.

### Other Configurations

In the present embodiment, the functions of “units” are realized by software as in Embodiment 1, however, the functions of “units” may be realized by hardware as in the modification of Embodiment 1. Alternatively, the functions of “units” may be realized by the combination of software and hardware.

### Embodiment 4

In the present embodiment, differences from Embodiment 1 will be mainly described.

In Embodiments 1 to 3, the filter strength is set according to at least one of the touch movement amount and the touch movement direction, but in the present embodiment, the filter strength is set considering that a magnitude of noise applied to the touch panel 103 varies depending on environment.

### Description of Configuration

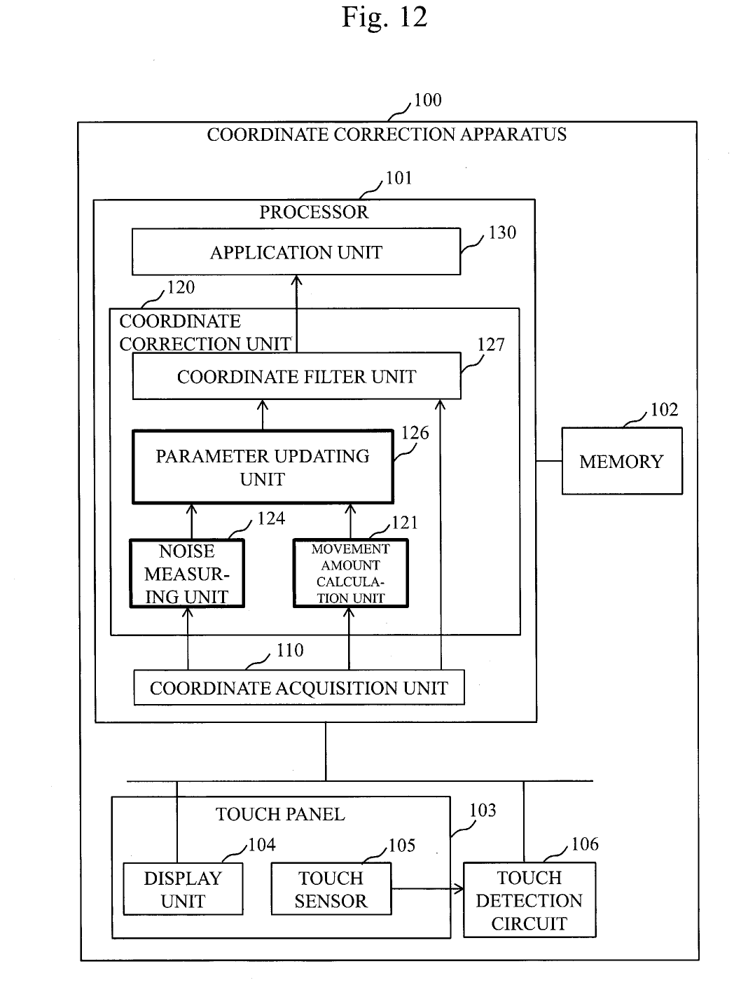

The configuration of the coordinate correction apparatus 100 according to the present embodiment will be described with reference to FIG. 12.

In the present embodiment, the coordinate correction unit 120 includes the movement amount calculation unit 121, a noise measuring unit 124, the parameter updating unit 126, and the coordinate filter unit 127.

### Description of Operation

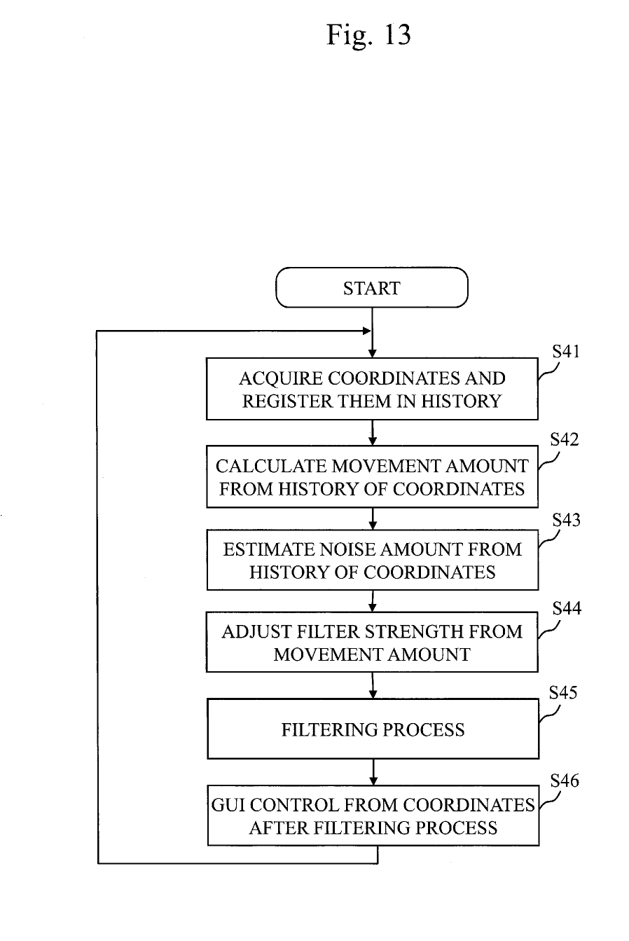

The operation of the coordinate correction apparatus 100 according to the present embodiment will be described with reference to FIG. 13. The operation of the coordinate correction apparatus 100 corresponds to a coordinate correction method according to the present embodiment. The operation of the coordinate correction apparatus 100 corresponds to processing procedures of a coordinate correction program according to the present embodiment.

Since processes in Step S41 and Step S42 are the same as processes in Step S12 and Step S13 in Embodiment 1, description thereof will be omitted.

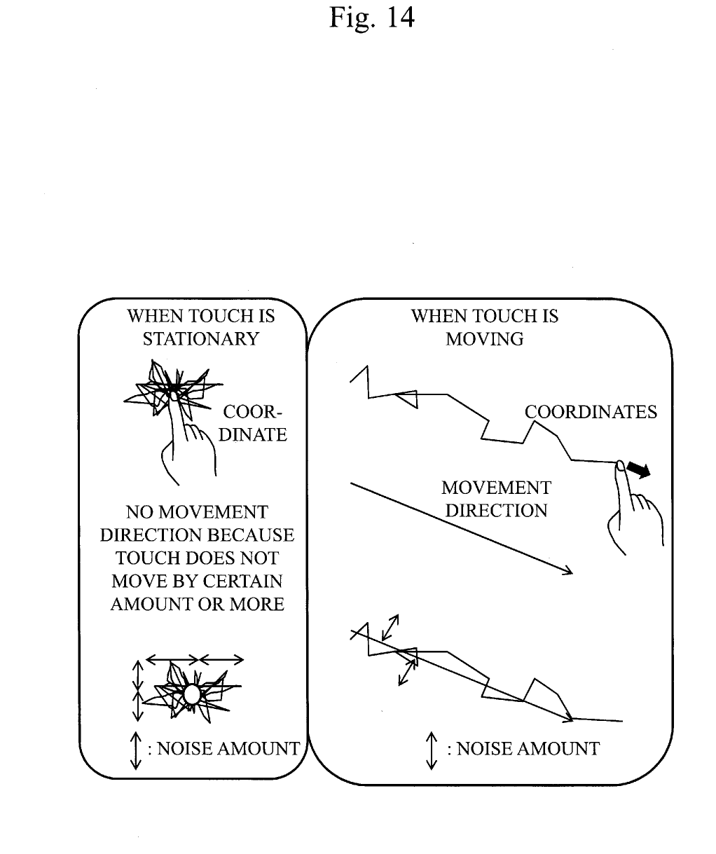

In Step S43, the noise measuring unit 124 estimates an amount of noise based on the history of the coordinates stored in the memory 102, and stores the amount of noise in the memory 102. Specifically, as shown in FIG. 14, the noise measuring unit 124 determines the touch movement direction from the coordinates of several samples. When the touch movement direction is not fixed, that is, when the touch is stationary, the noise measuring unit 124 extracts an outlier from the average value as the amount of noise. When the touch movement direction is fixed, that is, when the touch is moving, the noise measuring unit 124 extracts a distance between the touch movement direction and a vertical component of each pair of coordinates as the amount of noise. As a result, it is possible to detect coordinate movement by the touch operation and the coordinate shift due to noise without mistake. Alternatively, the noise measuring unit 124 extracts the amount of noise only when the touch movement direction is not fixed, and updates the amount of noise stored in the memory 102, so that the amount of noise can be obtained only when there is a movement estimated as the coordinate shift. Alternatively, the noise measuring unit 124 stores in the memory 102 a difference between previous coordinates and the current coordinates stored in the memory 102, and extracts a variance from the past to the present of this difference as the amount of noise. In this manner, by not including the touch movement amount in the variance, it is possible to estimate only the amount of noise. Alternatively, the noise measuring unit 124 estimates the noise amount by combining the history of the coordinates stored in the memory 102, the touch movement amount obtained in Step S42, and past filter results.

In Step S44, the parameter updating unit 126 sets the filter strength based on the touch movement amount obtained in Step S42 and the amount of noise obtained in Step S43. Specifically, the parameter updating unit 126 determines the filter strength from the touch movement amount and the amount of noise stored in the memory 102, and stores the filter strength parameter in the memory 102.

Since a process in Step S45 is the same as the process in Step S15 in Embodiment 1, detailed description thereof will be omitted, however, also in the present embodiment, the coordinate filter unit 127 performs the filtering process according to Equation 1 described above.

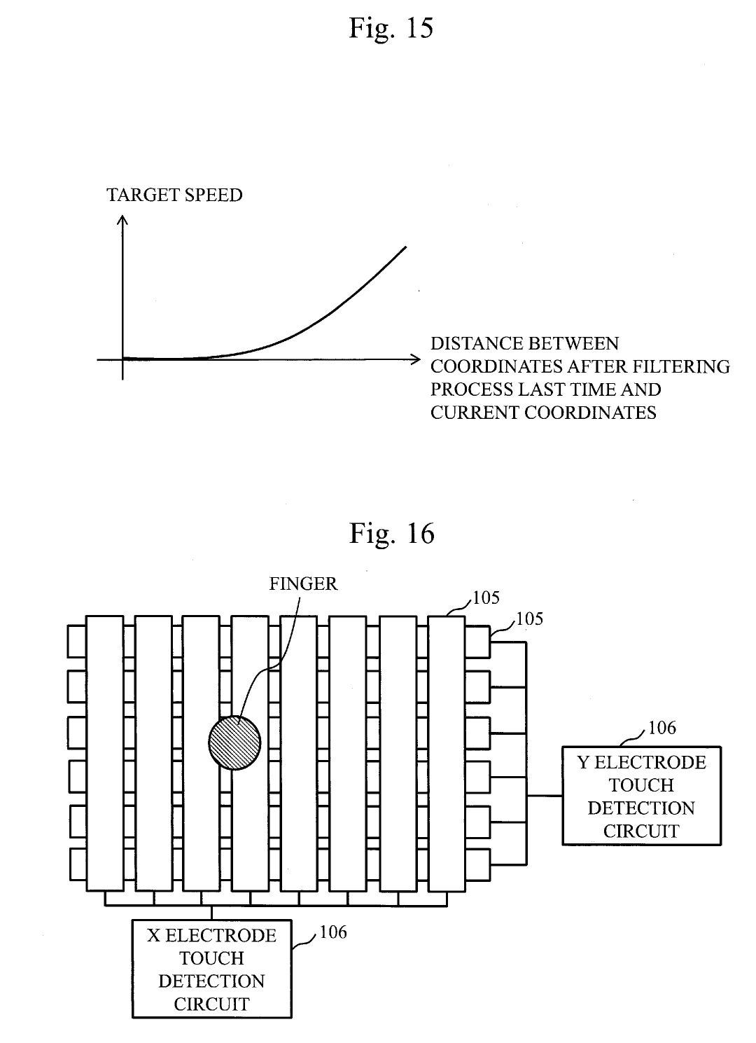

In step S44, the parameter updating unit 126 obtains the amount of noise and the touch movement amount from the memory 102, and adjusts W and V in Equation 1, so that the filter strength is determined in consideration of the magnitude of the noise and the touch movement amount of the finger. Specifically, the parameter updating unit 126 determines V as in Embodiment 1, reads an amount of noise 6 stored in the memory 102 by the noise measuring unit 124 for W, and sets W=C/G to adjust the filter strength. Here, C is an adjustment parameter for determining W. In the present embodiment, as shown in FIG. 15, the parameter updating unit 126 has a parameter of target speed corresponding to the touch movement amount, and sets the filter strength by using W determined from the amount of noise and V determined from the touch movement amount, and then readjusts W and V so that the moving speed of the coordinates after the filtering process does not fall below the target speed. When W is small, the delay increases if W is applied as it is, however, it is possible to filter the coordinates so that the delay does not increase by calculating W₀ (>W) in which the moving speed of the coordinates after the filtering process does not fall below the target speed from the current V to use it as a parameter for updating the filter. Further, when W is large, it is possible to perform the filtering process emphasizing the followability by applying the filter as it is. Note that the parameter updating unit 126 may adjust the filter strength by any method using an equation or table which defines a relationship between W and the amount of noise 6 from the past to the present.

Since a process in Step S46 is the same as the process in Step S16 in Embodiment 1, description thereof will be omitted.

After the process in Step S46, the process in Step S41 is performed again.

As described above, in Step S43, the coordinate correction unit 120 calculates as the amount of noise a difference between an average value of time series data of the coordinates acquired by the coordinate acquisition unit 110 and the coordinates included in the time series data. Alternatively, the coordinate correction unit 120 calculates a distance between an approximate straight line of the time series data of the coordinates acquired by the coordinate acquisition unit 110 and the coordinates included in the time series data as the amount of noise. In Step S44, as the calculated amount of noise is larger, the coordinate correction unit 120 sets the weight of the second coordinates larger.

In Step S45, when a distance between the calculation result of the weighted average and corrected coordinates output last time is smaller than a lower limit value varying depending on the touch movement amount, the coordinate correction unit 120 outputs coordinates obtained by adding the lower limit value to the corrected coordinates output last time as the corrected coordinates instead of the calculation result. The lower limit value may be set by any method, and as a specific example, the target speed can be set as described above.

As described above, in the present embodiment, the amount of noise is determined in addition to the touch movement amount, and the filter strength is switched by the amount of noise and the touch movement amount, so that the coordinates of the current touch position are filtered. Therefore, when the noise is small, the filter strength is not increased, so that the followability of the operation can be improved.

Since the amount of noise is automatically updated, even when the coordinate shift is increased due to environmental change, it is possible to appropriately prevent the coordinate shift without manual adjustment. It is possible to save time and labor of adjusting sensing of the touch detection circuit 106 in consideration of the environment in which the touch panel 103 is placed and of finely adjusting the filter strength in consideration of a degree of the coordinate shift.

In the present embodiment, by setting the target speed as shown in FIG. 15 in consideration of both the amount of noise and the touch movement amount, it is possible to adjust the filter strength while automatically maintaining desirable followability without fine adjustment according to the noise.

In the present embodiment, when the Kalman filter is used instead of Equation 1, the filter is applied so that the weight of the coordinates having a smaller error out of an observed value and the estimated coordinates is larger, similarly to a case where the Kalman filter is used in Embodiment 1. In order to adjust this weight, it is sufficient to set an observation error R and an error Q when estimating the coordinate position.

When this is applied to the filter strength of the present embodiment, assuming that the amount of noise determined by the noise measuring unit 124 is R and the touch movement amount calculated by the movement amount calculation unit 121 is Q, it is possible not only to adjust the weight according to the movement amount of the finger but also to adjust the weight according to the amount of noise. Since R is small when the amount of noise is small, the weight is calculated to use the observed coordinates themselves rather than the estimated values of the coordinates. Since R is large when the amount of noise is large, the weight is calculated to use the coordinates estimated from the moving speed and the like rather than the observed coordinates. This makes it possible to obtain the same effect as in case of increasing or decreasing W and V in Equation 1.

By increasing or decreasing the filter strength according to the amount of noise and the touch movement amount for all the filters using the coordinates other than the above, it is possible to obtain the same effect as in the present embodiment.

### Description of Effect of Embodiment

In the present embodiment, the filter is strengthened or weakened in consideration of not only the touch movement amount but also the degree of the coordinate shift of the touch position, that is, the amount of noise. Therefore, it is possible to deal with the fact that the magnitude of the noise applied to the touch panel 103 varies depending on the environment.

Further, in the present embodiment, the target speed is maintained when adjusting the filter strength according to the touch movement amount and the amount of noise. Therefore, it is possible to ensure the followability of the minimum operation.

The present embodiment can be applied to the Kalman filter as in Embodiment 1. Specifically, the error of the observed value obtained from the touch panel 103 is set in advance. The next touch position is estimated from the moving speed and the position of the coordinate point sequence given from the coordinate acquisition unit 110. The error of the estimated touch position is also set. The parameter updating unit 126 adjusts the filter strength according to the weight of the error of the estimated touch position and the error of the observed value. As the error of the observed value, a value corresponding to the amount of noise determined by the noise measuring unit 124 is set. As the error of the estimated touch position, the value corresponding to the touch movement amount calculated by the movement amount calculation unit 121 is set.

### Other Configurations

In the present embodiment, the functions of “units” are realized by software as in Embodiment 1, however, the functions of “units” may be realized by hardware as in the modification of Embodiment 1. Alternatively, the functions of “units” may be realized by the combination of software and hardware.

### Embodiment 5

In the present embodiment, differences from Embodiment 1 will be mainly described.

Influence of the coordinate shift due to power supply noise tends to depend on the touch position. Specifically, when the touch operation is performed on a pattern of the strip-shaped touch sensor 105 as shown in FIG. 16, the degree of the coordinate shift varies since a peak position of a sensor output changes depending on the touch position.

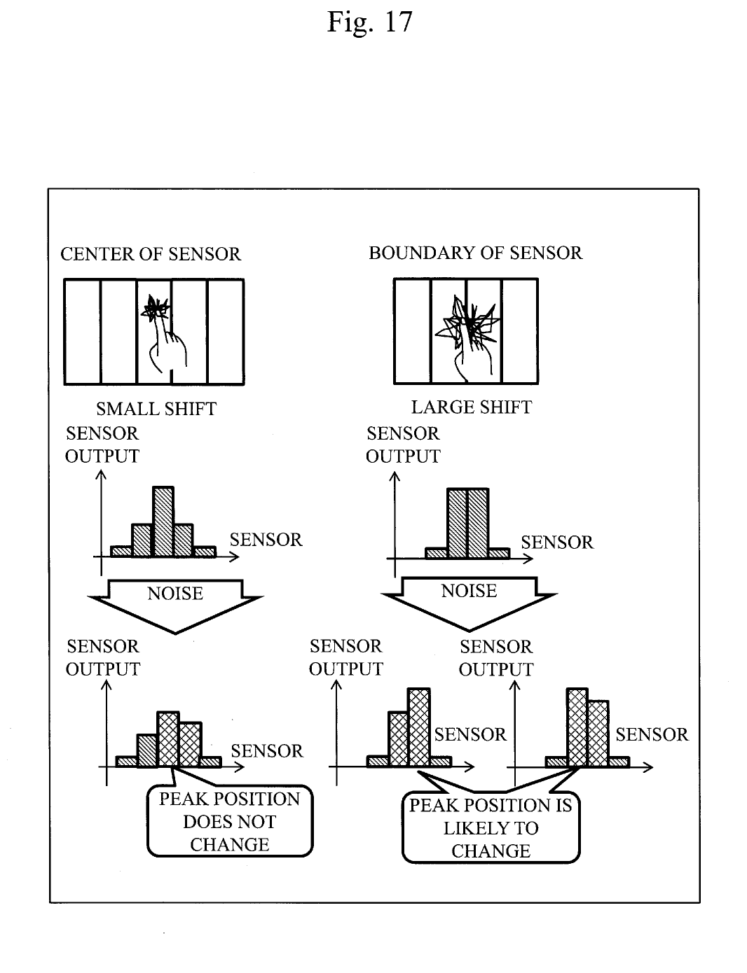

As a specific example, when a center position of the strip-shaped touch sensor 105 is touched as shown in FIG. 17, since the peak position of the sensor output often does not changes, the coordinate shift is small. On the other hand, when a boundary position between two touch sensors 105 is touched, since the peak position of the sensor output is likely to change, the coordinate shift is large. In the present embodiment, a change of the coordinate shift depending on such a touch position is prevented.

### Description of Configuration

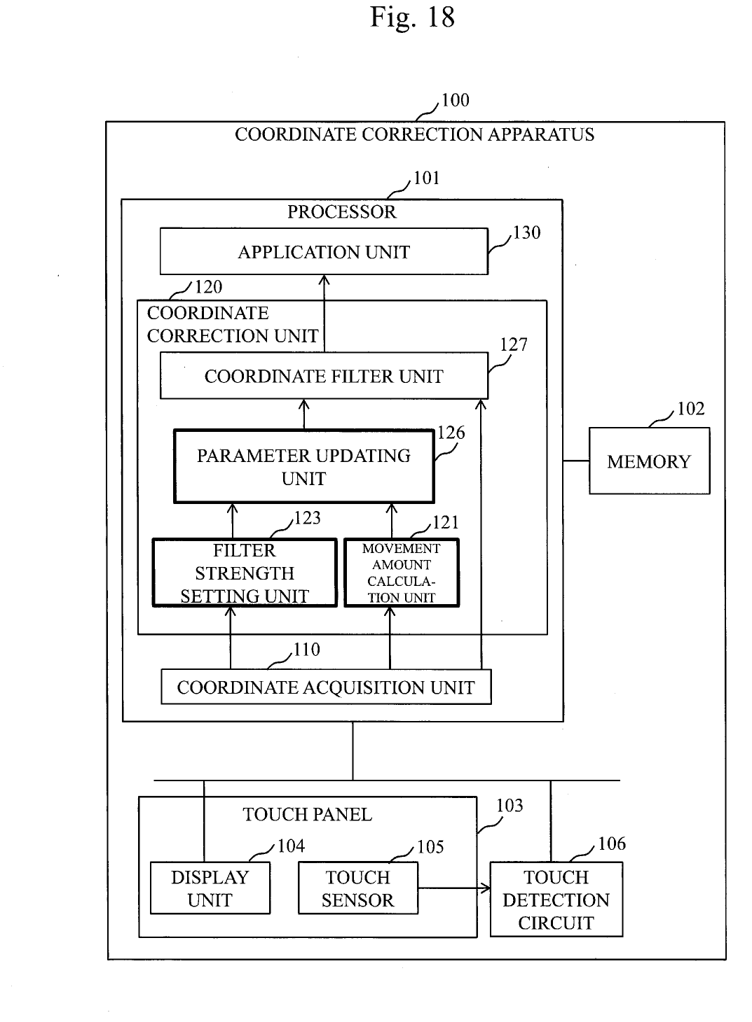

The configuration of the coordinate correction apparatus 100 according to the present embodiment will be described with reference to FIG. 18.

In the present embodiment, the coordinate correction unit 120 includes the movement amount calculation unit 121, the filter strength setting unit 123, the parameter updating unit 126, and the coordinate filter unit 127.

### Description of Operation

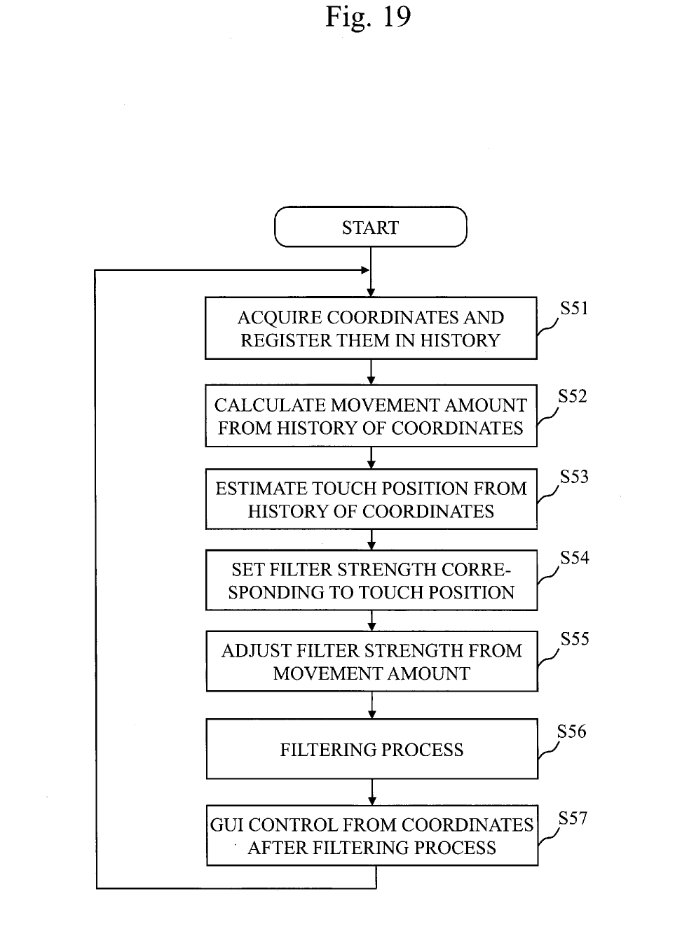

The operation of the coordinate correction apparatus 100 according to the present embodiment will be described with reference to FIG. 19. The operation of the coordinate correction apparatus 100 corresponds to a coordinate correction method according to the present embodiment. The operation of the coordinate correction apparatus 100 corresponds to processing procedures of a coordinate correction program according to the present embodiment.

Since processes in Step S51 and Step S52 are the same as processes in Step S12 and Step S13 in Embodiment 1, description thereof will be omitted.

In Step S53, the filter strength setting unit 123 estimates the position touched by the user. Specifically, the filter strength setting unit 123 estimates whether the touch position on the touch panel 103 is close to the boundary position of the two touch sensors 105 or close to the center position of the touch sensor 105 based on the history of the coordinates stored in the memory 102.

In Step S54, the filter strength setting unit 123 determines the filter strength from a correspondence relationship between a preset touch position and the filter strength. Specifically, the filter strength setting unit 123 sets the filter strength stronger as the position estimated in Step S53 is closer to the boundary position between the two touch sensors 105. The filter strength setting unit 123 sets the filter strength weaker as the position estimated in Step S53 is closer to the center position of the touch sensor 105. The filter strength setting unit 123 stores the filter strength parameter in the memory 102.

Since a process in Step S55 is almost the same as a process in Step S14 in Embodiment 1, detailed description thereof will be omitted, but in the present embodiment, the parameter updating unit 126 adjusts the filter strength based on the touch movement amount determined in Step S52.

Since a process in Step S56 is almost the same as the process in Step S15 in Embodiment 1, detailed description thereof will be omitted, however, also in the present embodiment, the coordinate filter unit 127 performs the filtering process according to Equation 1 described above.

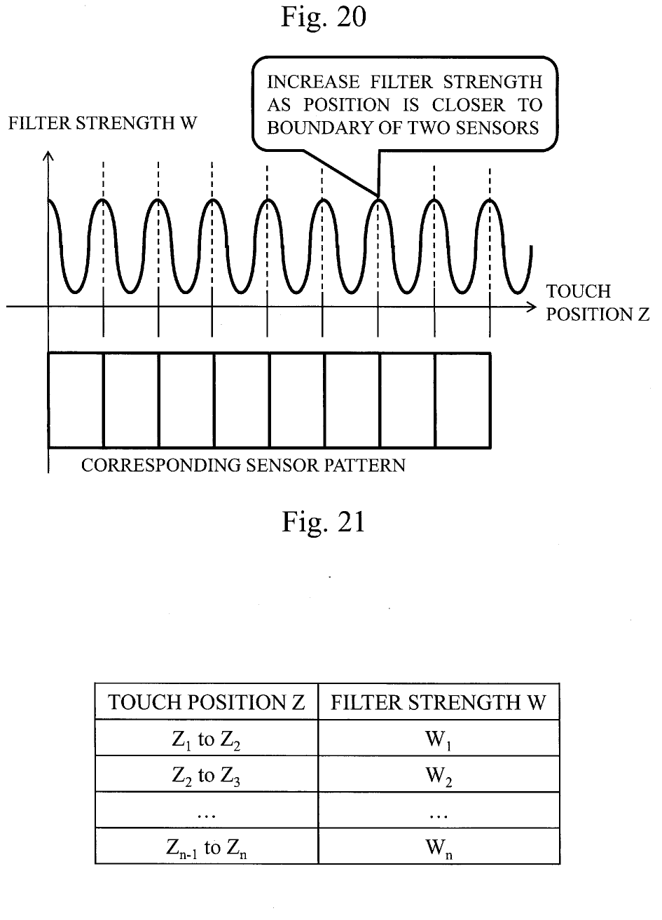

In Step S53 and Step S54, the filter strength setting unit 123 estimates the touch position by averaging the coordinates of several samples, and determines W in Equation 1 from a function of filter strength W corresponding to the touch position Z prepared in advance as shown in FIG. 20. Alternatively, the filter strength setting unit 123 determines Win Equation 1 by using a median value, a frequency distribution, or the like, or by using a table which specifies the filter strength W corresponding to the touch position Z as shown in FIG. 21.

In Step S55, the parameter updating unit 126 determines V in Equation 1 as in Embodiment 1.

Since a process in Step S57 is the same as the process in Step S16 in Embodiment 1, description thereof will be omitted.

After the process in Step S57, the process in Step S51 is performed again.

As described above, in Step S53, the coordinate correction unit 120 estimates from the first coordinates a relative position of a new touch position with respect to a plurality of touch sensors 105 provided in the touch panel 103. In Step S54, the coordinate correction unit 120 sets the weight of the second coordinates larger as the estimated relative position is closer to the boundary position of the two adjacent touch sensors 105.

As described above, in the present embodiment, since the filter strength is switched according to the estimated touch position in addition to the touch movement amount, it is possible to improve the followability of the operation by decreasing the filter strength in the case of the position where the coordinate shift is small considering a coordinate shift amount which increases or decreases according to the position.

Further, in the present embodiment, when the boundary position between the two touch sensors 105, which are likely to be affected by the power supply noise, is pressed, it is possible to further prevent the erroneous recognition of the operation by increasing the filter strength.

### Description of Effect of Embodiment

In the present embodiment, the filter is strengthened or weakened by the touch position in addition to the touch movement amount. Therefore, it is possible to prevent the change of the coordinate shift depending on the touch position.

### Other Configurations

In the present embodiment, the functions of “units” are realized by software as in Embodiment 1, however, the functions of “units” may be realized by hardware as in the modification of Embodiment 1. Alternatively, the functions of “units” may be realized by the combination of software and hardware.

### Embodiment 6

In the present embodiment, differences from Embodiment 5 will be mainly described.

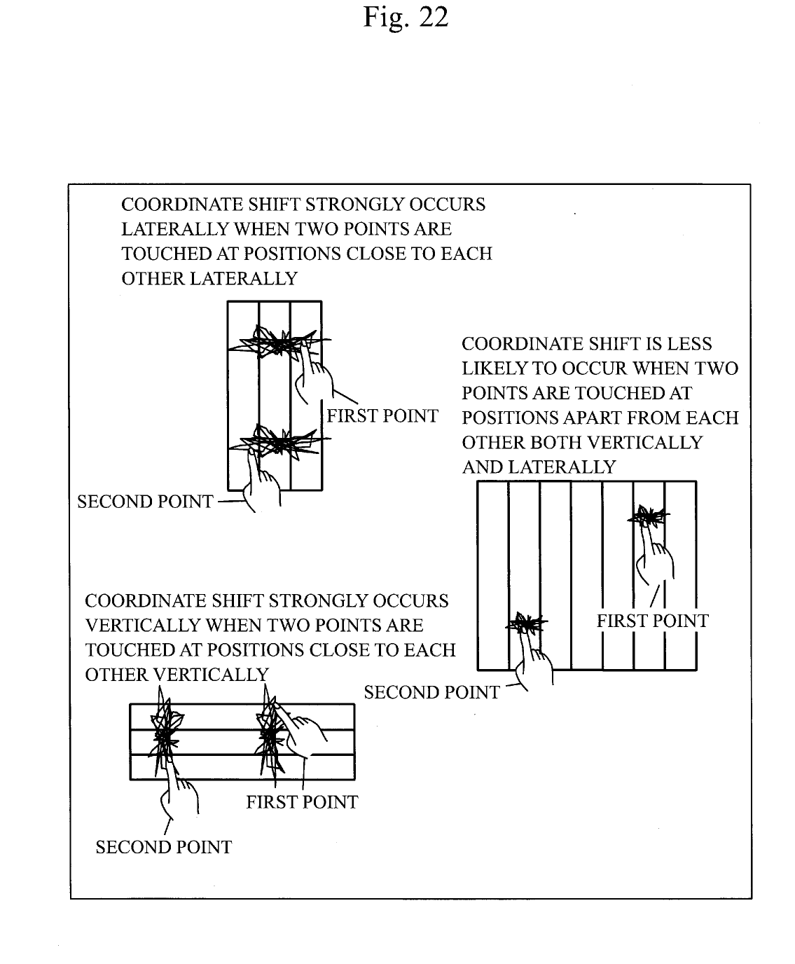

When the two-point touch operation is performed, the coordinate shift may increase or decrease depending on a positional relationship between the two points. Specifically, as shown in FIG. 22, when the two points close to each other in a lateral direction are touched, a large coordinate shift tends to occur in the lateral direction. When the two points close to each other in a vertical direction are touched, a large coordinate shift tends to occur in the vertical direction. When the two points apart from each other in both the vertical and lateral directions are touched, the coordinate shift is less likely to occur. In the present embodiment, considering that the coordinate shift increases or decreases also depending on the positional relationship between the two points as described above, the filter is strengthened or weakened according to the positional relationship between the two points.

### Description of Configuration

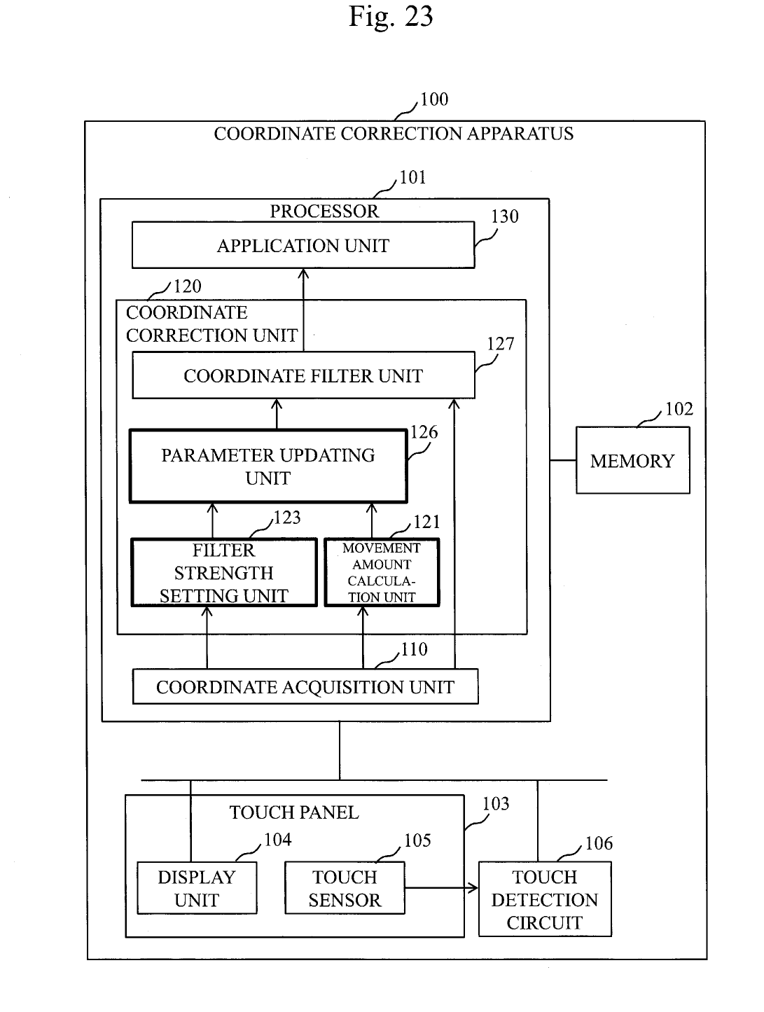

The configuration of the coordinate correction apparatus 100 according to the present embodiment will be described with reference to FIG. 23.

In the present embodiment, the coordinate correction unit 120 includes the movement amount calculation unit 121, the filter strength setting unit 123, the parameter updating unit 126, and the coordinate filter unit 127.

### Description of Operation

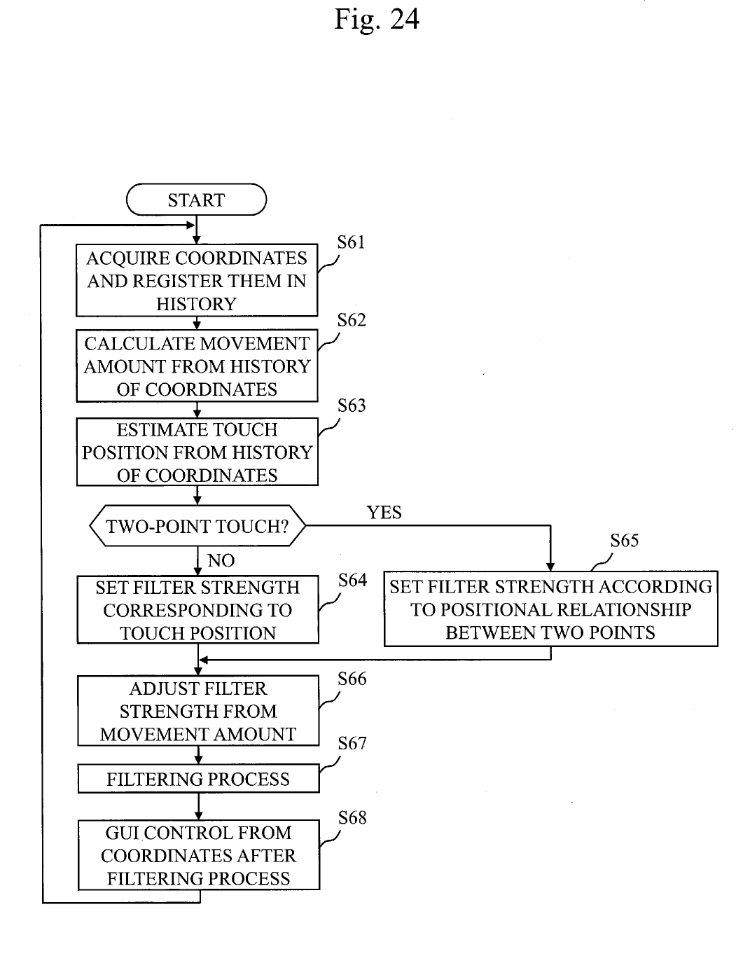

The operation of the coordinate correction apparatus 100 according to the present embodiment will be described with reference to FIG. 24. The operation of the coordinate correction apparatus 100 corresponds to a coordinate correction method according to the present embodiment. The operation of the coordinate correction apparatus 100 corresponds to processing procedures of a coordinate correction program according to the present embodiment.

Since processes in Step S61 and Step S62 are the same as the processes in Step S51 and Step S52 in Embodiment 5, description thereof will be omitted.

In Step S63, the filter strength setting unit 123 estimates the position touched by the user. Specifically, the filter strength setting unit 123 determines whether the user is touching one point or two points. When one point is being touched, the filter strength setting unit 123 determines whether the touch position on the touch panel 103 is close to the boundary position between the two touch sensors 105 or close to the center position of one touch sensor 105 based on the history of the coordinates stored in the memory 102. Then, the filter strength setting unit 123 proceeds to a process in Step S64. When two points are being touched, the filter strength setting unit 123 determines the vertical and lateral distances between the touch positions of the two points based on the history of the coordinates stored in the memory 102. That is, the filter strength setting unit 123 specifies the positional relationship between the touch positions of the two points. Then, the filter strength setting unit 123 proceeds to a process in Step S65.

Since a process in Step S64 is the same as a process in Step S54 in Embodiment 5, description thereof will be omitted.

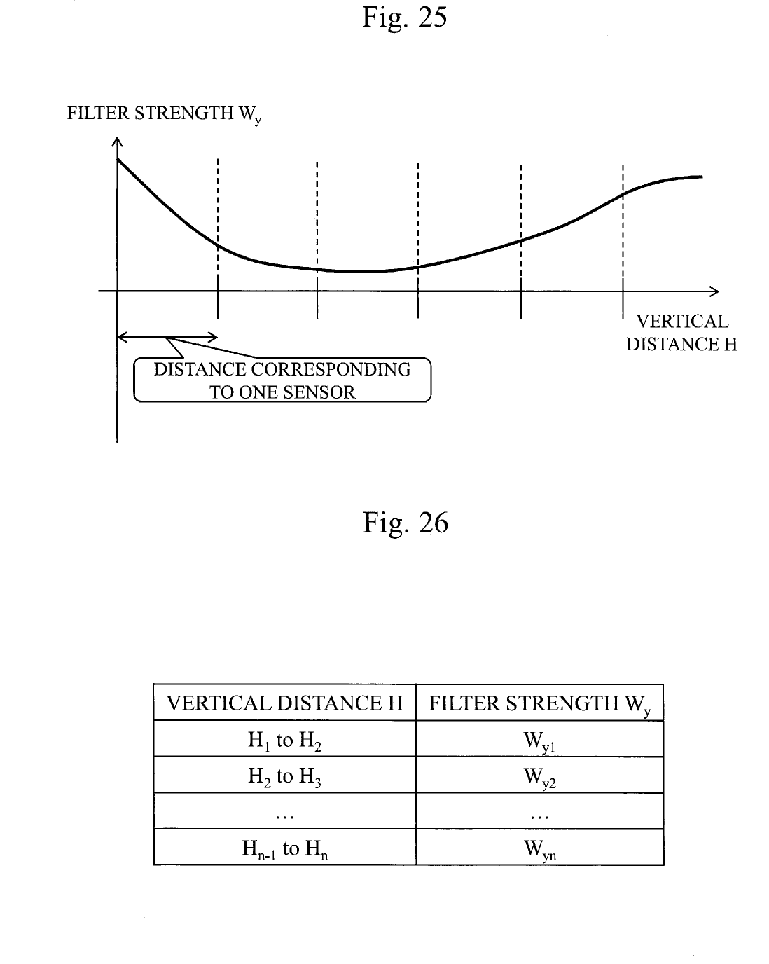

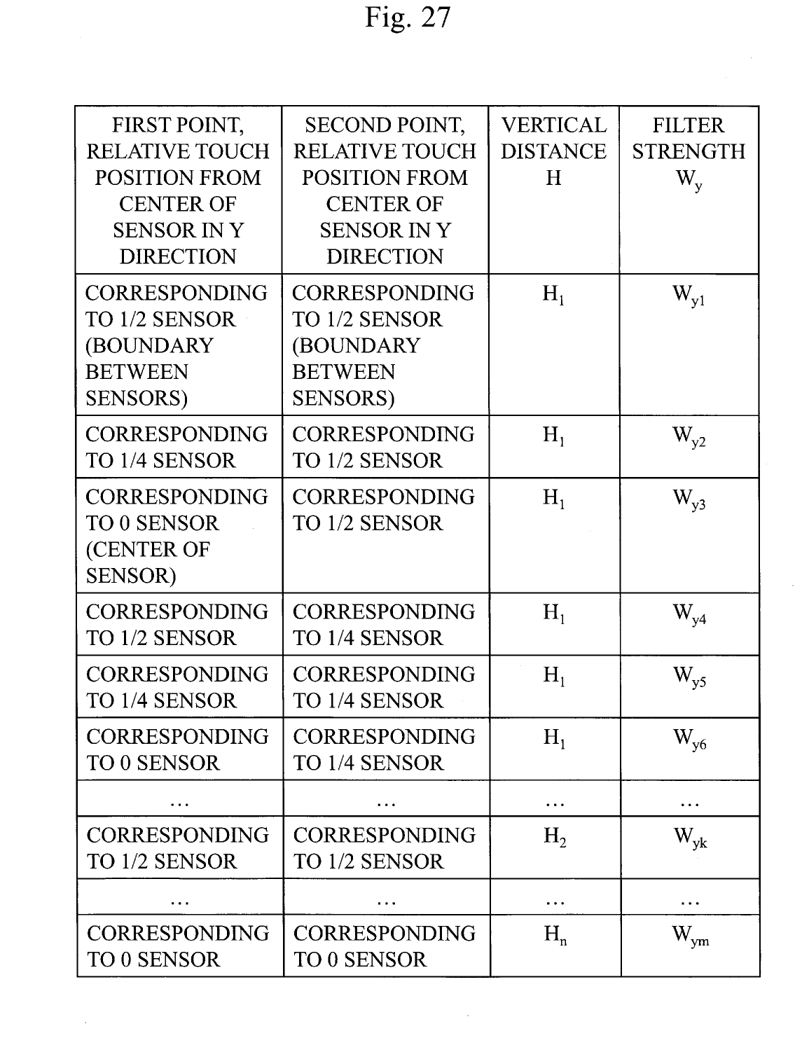

In Step S65, the filter strength setting unit 123 determines the filter strength W_{y} from a vertical distance H between the touch positions of the two points determined in Step S63 using a function as shown in FIG. 25. The filter strength setting unit 123 determines a filter strength Wₓ from a lateral distance between the touch positions of the two points determined in Step S63 using the same function. Alternatively, the filter strength setting unit 123 determines the filter strength W_{y} from the vertical distance H between the touch positions of the two points determined in Step S63 with reference to a table as shown in FIG. 26. The filter strength setting unit 123 determines the filter strength Wₓ from the lateral distance between the touch positions of the two points determined in Step S63 with reference to the same table. Alternatively, the filter strength setting unit 123 determines the filter strength W_{y} with reference to a table as shown in FIG. 27 in consideration of not only the vertical distance H between the touch positions of the two points determined in Step S63 but also the relative position of the touch position with respect to the touch sensor 105 estimated in the same way as when one point is being touched. The filter strength setting unit 123 determines the filter strength W, with reference to the same table in consideration of not only the lateral distance between the touch positions of the two points determined in Step S63 but also the relative position of the touch position with respect to the touch sensor 105 estimated in the same way as when one point is being touched.

After either of the process in Step S64 and the process in Step S65 is performed, a process in Step S66 is performed.

Since the process in Step S66 is the same as the process in Step S55 in Embodiment 5, detailed description thereof will be omitted.

In Step S67, the coordinate filter unit 127 uses W determined in Step S64 as Wₓ and W_{y} when one point is being touched, performs the filtering process for an X direction and a Y direction respectively according to the following Equations 2 and 3, and stores the obtained result in the memory 102. The X direction is the horizontal direction. The Y direction is the vertical direction. When two points are being touched, the coordinate filter unit 127 performs the filtering process for the X direction and the Y direction respectively according to the following Equations 2 and 3 with Wₓ and W_{y} determined in Step S65, and stores the obtained result in the memory 102.

Pᵢ=(Wₓ·X+V·Pᵢ₋₁)/(Wₓ+V) Equation 2

Qᵢ=(W_{y}·Y+V·Qᵢ₋₁)/(W_{y}+V) Equation 3

Here, Pᵢ and Qᵢ are the coordinates after the filtering process, Pᵢ₋₁ and Qᵢ₋₁ are the coordinates filtered last time, X is an X coordinate of the obtained current touch position, Y is a Y coordinate of the obtained current touch position, Wₓ and W_{y} are the filter strengths determined by the filter strength setting unit 123, and V is the filter strength adjusted by the parameter updating unit 126. In Equation 2 and Equation 3, when there are no coordinates filtered last time, P₀=X and Q₀=Y.

Since a process in Step S68 is the same as the process in Step S57 in Embodiment 5, description thereof will be omitted.

After the process in Step S68, the process in Step S61 is performed again.

As described above, in Step S61, the coordinate acquisition unit 110 sequentially acquires the coordinates of the touch positions on the touch panel 103 when the multi-touch operation of simultaneously performing the touch operations at the plurality of positions on the touch panel 103 is continued. In Step S65 and Step S67, the weighting applied by the coordinate correction unit 120 varies depending on the positional relationship between the plurality of touch positions when the coordinate acquisition unit 110 acquires the coordinates of the plurality of touch positions as the first coordinates.

As described above, in the present embodiment, since the filter strength is changed according to the touched position and the positional relationship between the two points, an appropriate filtering process can be performed not only at a time of one-point touch operation but also at a time of two-point touch operation in which characteristics of the coordinate shift are changed.

In the present embodiment, the filter strength is increased or decreased according to the positional relationship between the touch points at the time of the two-point touch operation, however, even when there are touch operations of three or more points, the filter strength can be increased or decreased according to the positional relationship between the touch points.

### Description of Effect of Embodiment

In the present embodiment, the filter is strengthened or weakened by the positional relationship between two touch positions in addition to the touch movement amount. Therefore, it is possible to prevent the change of the coordinate shift depending on the positional relationship between two touch positions.

### Other Configurations

In the present embodiment, the functions of “units” are realized by software as in Embodiment 1, however, the functions of “units” may be realized by hardware as in the modification of Embodiment 1. Alternatively, the functions of “units” may be realized by the combination of software and hardware.

### Embodiment 7

In the present embodiment, differences from Embodiment 1 will be mainly described.

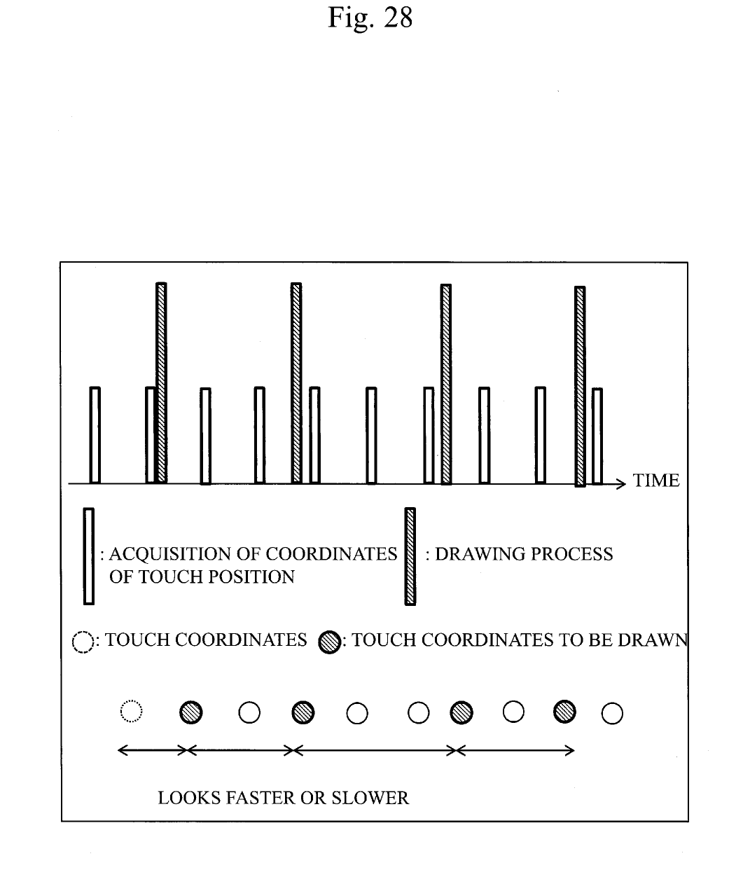

As shown in FIG. 28, a sampling interval (hereinafter referred to as a “touch interval”) of the coordinates output by the touch panel 103 and an interval (hereinafter referred to as a “drawing interval”) in which the GUI component moves by the touch operation and is actually reflected on the display are different. Therefore, moving speed of the GUI component is increased or decreased in some cases. In the present embodiment, such variation in the moving speed is prevented.

### Description of Configuration

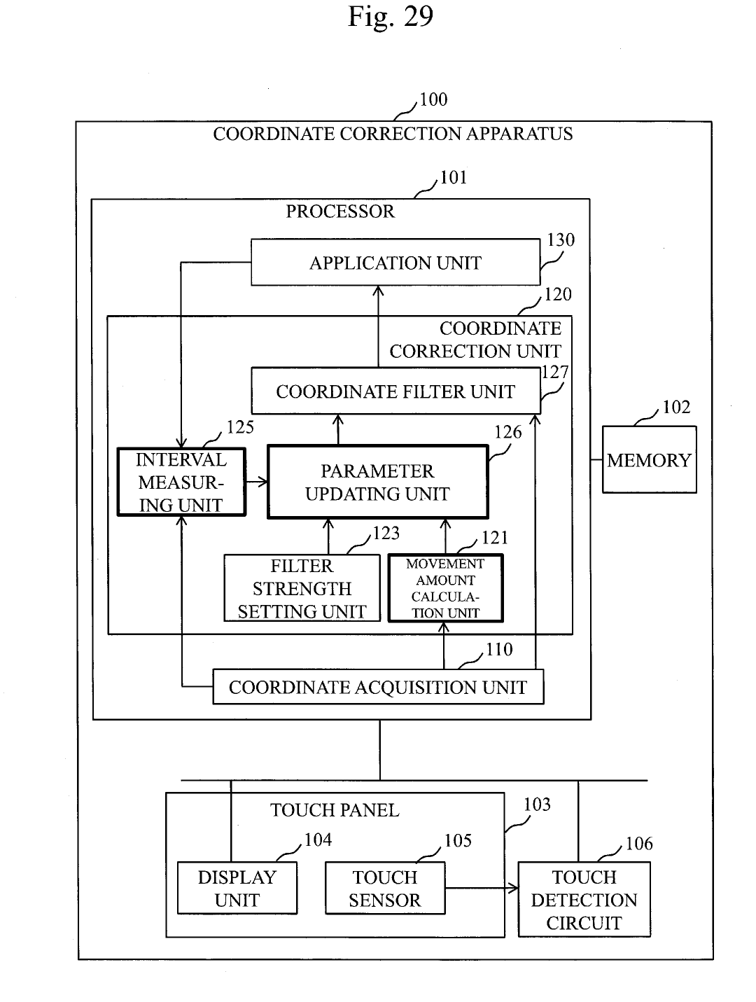

The configuration of the coordinate correction apparatus 100 according to the present embodiment will be described with reference to FIG. 29.

In the present embodiment, the coordinate correction unit 120 includes the movement amount calculation unit 121, the filter strength setting unit 123, an interval measuring unit 125, the parameter updating unit 126, and the coordinate filter unit 127.

### Description of Operation

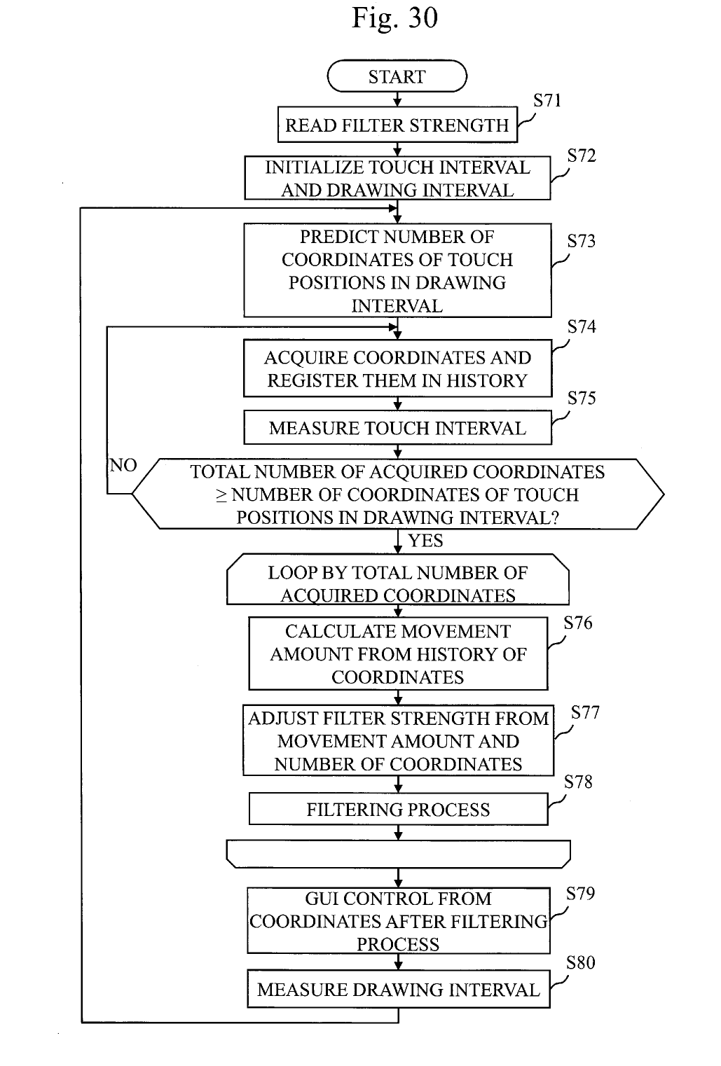

The operation of the coordinate correction apparatus 100 according to the present embodiment will be described with reference to FIG. 30. The operation of the coordinate correction apparatus 100 corresponds to a coordinate correction method according to the present embodiment. The operation of the coordinate correction apparatus 100 corresponds to processing procedures of a coordinate correction program according to the present embodiment.

Since a process in Step S71 is the same as the process in Step S1l in Embodiment 1, description thereof will be omitted.

In Step S72, the interval measuring unit 125 initializes variables of the touch interval and the drawing interval. As a specific example, when drawing performance of 60 frames per second (fps) is a target value, the interval measuring unit 125 initializes the variable of the drawing interval at about 16 milliseconds and sets an interval measured in advance for the variable of the touch interval. Each variable is stored in the memory 102.

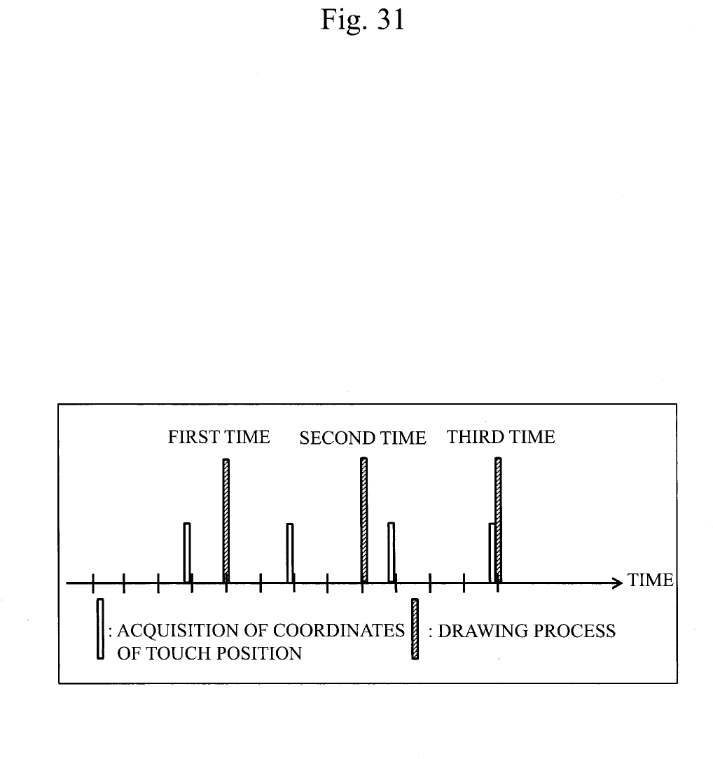

In Step S73, the interval measuring unit 125 predicts the number of coordinates of the touch positions obtained until a next drawing based on the variables of the touch interval and the drawing interval stored in the memory 102. As a specific example, when the drawing interval is 16 milliseconds and the touch interval is 12 milliseconds, as shown in FIG. 31, the number of coordinates of the touch positions obtained after first drawing until a time of second drawing is one, however, the number of coordinates of the touch positions obtained thereafter until a time of third drawing is two.

Since a process in Step S74 is the same as the process in Step S12 in Embodiment 1, description thereof will be omitted.

In Step S75, the interval measuring unit 125 measures the touch interval from times when the coordinates are acquired in Step S74, and updates the variable stored in the memory 102.

The interval measuring unit 125 repeats the processes of Step S74 and Step S75 until as many coordinates of the touch positions as the number of coordinates to be acquired until the next drawing are acquired.

Processes from Step S76 to Step S78 are repeated by the number of the coordinates acquired.

Since the process in Step S76 is almost the same as the process in Step S13 in Embodiment 1, detailed description thereof will be omitted, but in the present embodiment, the movement amount calculation unit 121 calculates the touch movement amount for corresponding coordinates based on the history of the coordinates stored in the memory 102 by the coordinate acquisition unit 110.

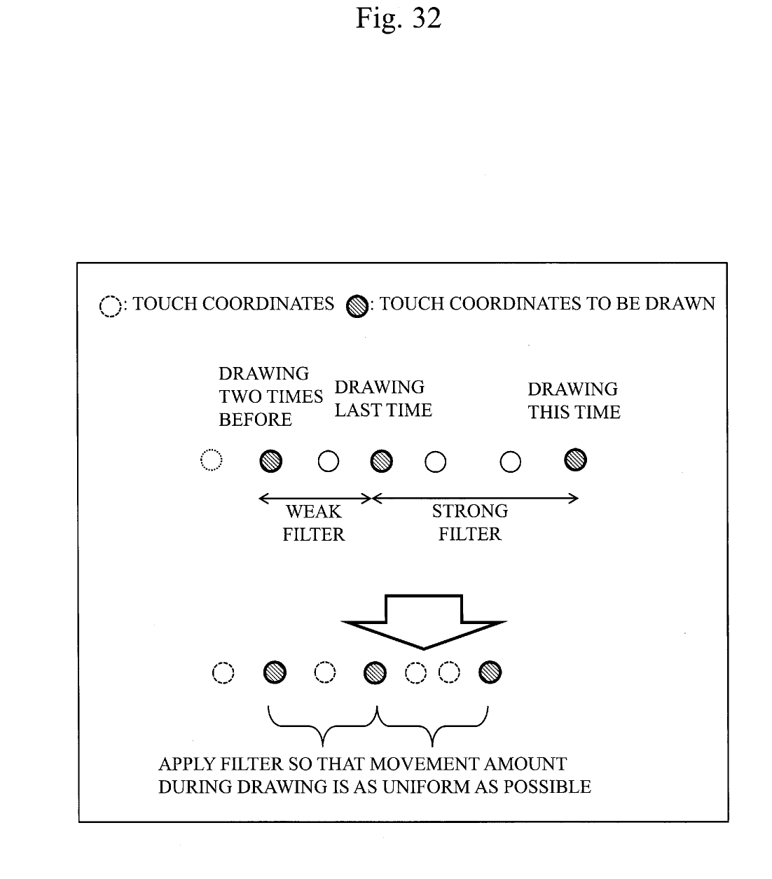

In Step S77, the parameter updating unit 126 adjusts V in Equation 1 from a total number of the coordinates acquired until drawing last time, the touch movement amount last time, and a total number of the coordinates acquired until drawing this time, so that final coordinates after the filtering process does not advance much. Specifically, as shown in FIG. 32, when a total number of the coordinates of the touch positions acquired from the drawing last time to the drawing this time is greater than a total number of the coordinates of the touch positions acquired from drawing two times before to the drawing last time, the filter strength V may be increased.

Since processes in Step S78 and Step S79 are the same as the processes in Step S15 and Step S16 in Embodiment 1, description thereof will be omitted.

In Step S80, the interval measuring unit 125 measures the drawing interval and updates the variable stored in the memory 102. Then, the interval measuring unit 125 returns to a process in Step S73.

In the present embodiment, the total number of coordinates of the touch positions acquired until the next drawing is predicted based on the touch interval and the drawing interval, however, notification may be sent to the interval measuring unit 125 each time the application unit 130 becomes capable of drawing. In that case, the touch movement amount is determined for the touch point acquired until the notification is sent, and the parameter of filter is adjusted.

As described above, in the present embodiment, the coordinate correction unit 120 predicts the number of coordinates acquired by the coordinate acquisition unit 110 for each drawing interval of graphics on the touch panel 103, and sets the weight of the second coordinates larger as the predicted number is larger.

As described above, in the present embodiment, by strengthen or weaken the filter in consideration of the drawing interval and the touch interval, it is possible to smoothly move the GUI component without finely adjusting performance of the touch panel 103 and drawing performance of the GUI. As a specific example of the moving GUI component, there is a scroll bar at a time of scrolling operation.

When the drawing interval and the touch interval are the same, it is not necessary to adjust the drawing interval, however, in situations where the power supply noise occurs, it is possible to perform the filtering process in which the coordinate shift and the delay are prevented by acquiring the coordinates of as many touch positions as possible. Therefore, it is effective to consider the drawing interval while making the touch interval as short as possible.

### Description of Effect of Embodiment

In the present embodiment, the filter is strengthened or weakened in consideration of the number of the touch points to be acquired until the next drawing in addition to the touch movement amount. Specifically, the parameter updating unit 126 increases the filter strength when the number of touch points predicted by the interval measuring unit 125 is larger than the previous number, and thus it is possible to make the touch movement amount for each drawing interval constant.

### Other Configurations

In the present embodiment, the functions of “units” are realized by software as in Embodiment 1, however, the functions of “units” may be realized by hardware as in the modification of Embodiment 1. Alternatively, the functions of “units” may be realized by the combination of software and hardware.

Although the embodiments of the present invention have been described above, two or more embodiments of these embodiments may be combined and implemented. Alternatively, one of these embodiments or a combination of two or more of the embodiments may be partially implemented. Specifically, only some of functional elements of the coordinate correction apparatus 100 according to these embodiments may be adopted. It should be noted that the present invention is not limited to these embodiments, but various modifications are possible as necessary.

### REFERENCE SIGNS LIST

100: coordinate correction apparatus, 101: processor, 102: memory, 103: touch panel, 104: display unit, 105: touch sensor, 106: touch detection circuit, 110: coordinate acquisition unit, 120: coordinate correction unit, 121: movement amount calculation unit, 122: movement direction estimation unit, 123: filter strength setting unit, 124: noise measuring unit, 125: interval measuring unit, 126: parameter updating unit, 127: coordinate filter unit, 130: application unit.

1.-14. (canceled)

15. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the processing circuitry sequentially acquires coordinates of pluralities of touch positions on the touch panel when a multi-touch operation of performing touch operations simultaneously at a plurality of positions on the touch panel is continued, and
when coordinates of a plurality of touch positions are acquired as the first coordinates and a difference between touch movement directions in the plurality of positions is equal to or smaller than a threshold value, the processing circuitry sets a weight of the second coordinates larger in a position where the touch movement amount is larger among the plurality of positions.

16. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the processing circuitry sequentially acquires coordinates of pluralities of touch positions on the touch panel when a multi-touch operation of performing touch operations simultaneously at a plurality of positions on the touch panel is continued, and
when coordinates of a plurality of touch positions are acquired as the first coordinates, the weighting applied varies according to a positional relationship between the plurality of touch positions.

17. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the processing circuitry calculates as a noise amount a difference between an average value of time-series data of the coordinates acquired and coordinates included in the time-series data, and sets a weight of the second coordinates larger as the calculated noise amount is larger.

18. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the processing circuitry calculates as a noise amount a distance between an approximate straight line of time-series data of the coordinates acquired and coordinates included in the time-series data, and sets a weight of the second coordinates larger as the calculated noise amount is larger.

19. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the processing circuitry estimates a relative position of the new touch position with respect to a plurality of touch sensors provided on the touch panel from the first coordinates, and sets a weight of the second coordinates larger as the estimated relative position is closer to a boundary position between two mutually adjacent touch sensors.

20. The coordinate correction apparatus according to claim 15, wherein the processing circuitry sets a weight of the second coordinates larger as the touch movement amount is smaller.

21. The coordinate correction apparatus according to claim 16, wherein the processing circuitry sets a weight of the second coordinates larger as the touch movement amount is smaller.

22. The coordinate correction apparatus according to claim 18, wherein the processing circuitry sets a weight of the second coordinates larger as the touch movement amount is smaller.

23. The coordinate correction apparatus according to claim 19, wherein the processing circuitry sets a weight of the second coordinates larger as the touch movement amount is smaller.

24. The coordinate correction apparatus according to claim 15, wherein the processing circuitry sets a weight of the second coordinates larger as a change in the touch movement direction is larger.

25. The coordinate correction apparatus according to claim 16, wherein the processing circuitry sets a weight of the second coordinates larger as a change in the touch movement direction is larger.

26. The coordinate correction apparatus according to claim 18, wherein the processing circuitry sets a weight of the second coordinates larger as a change in the touch movement direction is larger.

27. The coordinate correction apparatus according to claim 19, wherein the processing circuitry sets a weight of the second coordinates larger as a change in the touch movement direction is larger.

28. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the processing circuitry sets a weight of the second coordinates larger as a change in the touch movement direction is larger.

29. The coordinate correction apparatus according to claim 15, wherein the second coordinates are coordinates estimated to be acquired next from the coordinates of the past touch position.

30. The coordinate correction apparatus according to claim 16, wherein the second coordinates are coordinates estimated to be acquired next from the coordinates of the past touch position.

31. The coordinate correction apparatus according to claim 17, wherein the second coordinates are coordinates estimated to be acquired next from the coordinates of the past touch position.

32. The coordinate correction apparatus according to claim 18, wherein the second coordinates are coordinates estimated to be acquired next from the coordinates of the past touch position.

33. The coordinate correction apparatus according to claim 28, wherein the second coordinates are coordinates estimated to be acquired next from the coordinates of the past touch position.

34. A coordinate correction apparatus comprising processing circuitry:
to sequentially acquire coordinates of touch positions on a touch panel when a touch operation is continued on the touch panel; and
to, when first coordinates which are coordinates of a new touch position are acquired, calculate a weighted average of the first coordinates and second coordinates determined from coordinates of a past touch position acquired, with applying weighting that varies according to at least one of a touch movement amount and a touch movement direction on the touch panel, and output a calculation result as corrected coordinates, wherein
the second coordinates are coordinates estimated to be acquired next from the coordinates of the past touch position.
